(19) United States
(12) Patent Application Publication
(10) Pub. No.: US 2021/0320776 A1
(43) Pub. Date: Oct. 14, 2021

(54) USER EQUIPMENTS, BASE STATIONS AND METHODS FOR CSI REPORTING

(71) Applicants: SHARP KABUSHIKI KAISHA, Sakai City, Osaka (JP); FG Innovation Company Limited, Tuen Mun, New Territories (HK)

(72) Inventors: TATSUSHI AIBA, Sakai City, Osaka (JP); ZHANPING YIN, Vancouver, WA (US); KAI YING, Vancouver, WA (US); KAZUNARI YOKOMAKURA, Sakai City, Osaka (JP)

(73) Assignees: SHARP KABUSHIKI KAISHA, Sakai City, Osaka (JP); FG Innovation Company Limited, Tuen Mun, New Territories (HK); FG Innovation Company Limited, Tuen Mun, New Territories (HK)

(21) Appl. No.: 17/261,104

(22) PCT Filed: Jun. 21, 2019
(86) PCT No.: PCT/JP2019/024785

§ 371 Date: Jan. 18, 2021

Related U.S. Application Data
(60) Provisional application No. 62/701,215, filed on Jul. 20, 2018.

(51) Int. Cl. H04L 5/00; H04W 72/04; H04L 1/00

(52) U.S. Cl. CPC H04L 5/0057; H04L 1/0061; H04W 72/042

(57) ABSTRACT

A user equipment (UE) is described. The UE includes receiving circuitry configured to receive a downlink control information (DCI) format. The DCI format includes a channel state information (CSI) request field set to trigger an aperiodic CSI reporting. The UE also includes transmitting circuitry configured to perform, based on the detection of the DCI format. The aperiodic CSI reporting includes a channel quality indicator (CQI) using a physical uplink shared channel (PUSCH). In a case that cyclic redundancy check (CRC) attached to the DCI format is scrambled by a cell radio network temporary identifier (C-RNTI), a first CQI table is used for interpretation for indices of the CQI. In a case that CRC attached to the DCI format is scrambled by a first RNTI different from the C-RNTI, a second CQI table is used for interpretation for indices of the CQI.

### TECHNICAL FIELD

The present disclosure relates generally to communication systems. More specifically, the present disclosure relates to new signaling, procedures, user equipment (UE) and base stations for channel state information (CSI) reporting.

### BACKGROUND ART

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### SUMMARY OF INVENTION

In one example, a user equipment (UE) comprising receiving circuitry configured to receive a downlink control information (DCI) format, the DCI format comprising a channel state information (CSI) request field set to trigger an aperiodic CSI reporting, and transmitting circuitry configured to perform, based on the detection of the DCI format, the aperiodic CSI reporting comprising a channel quality indicator (CQI) using a physical uplink shared channel (PUSCH), wherein in a case that cyclic redundancy check (CRC) attached to the DCI format is scrambled by a cell radio network temporary identifier (C-RNTI), a first CQI table is used for interpretation for indices of the CQI, and in a case that CRC attached to the DCI format is scrambled by a first RNTI different from the C-RNTI, a second CQI table is used for interpretation for indices of the CQI.

In one example, a user equipment (UE), comprising receiving circuitry configured to receive a radio resource control (RRC) message comprising information used for configuring a correspondence between a trigger state of a channel state information (CSI) request field and a channel quality indicator (CQI) table, the receiving circuitry configured to receive a downlink control information (DCI) format, the DCI format comprising a CSI request field set to trigger an aperiodic CSI reporting, and transmitting circuitry configured to perform, based on the detection of the DCI format, the aperiodic CSI reporting comprising a channel quality indicator (CQI) using a physical uplink shared channel (PUSCH), wherein the CQI table used for interpretation for indices of the CQI is determined based on the information and the trigger state of the CSI request field.

In one example, a base station apparatus comprising transmitting circuitry configured to transmit a downlink control information (DCI) format, the DCI format comprising a channel state information (CSI) request field set to trigger an aperiodic CSI reporting, and receiving circuitry configured to receive, based on the DCI format, the aperiodic CSI reporting comprising CQI using a physical uplink shared channel (PUSCH), wherein

in a case that cyclic redundancy check (CRC) attached to the DCI format is scrambled by a cell radio network temporary identifier (C-RNTI), a first CQI table is used for interpretation for indices of the CQI, and in a case that CRC attached to the DCI format is scrambled by a first RNTI different from the C-RNTI, a second CQI table is used for interpretation for indices of the CQI.

In one example, a base station apparatus comprising transmitting circuitry configured to transmit a radio resource control (RRC) message comprising information used for configuring a correspondence between a trigger state of a channel state information (CSI) request field and a channel quality indicator (CQI) table, the transmitting circuitry configured to transmit a downlink control information (DCI) format, the DCI format comprising a CSI request field set to trigger an aperiodic CSI reporting, and receiving circuitry configured to receive, based on the DCI format, the aperiodic CSI reporting comprising CQI using a physical uplink shared channel (PUSCH), wherein the CQI table used for interpretation for indices of the CQI is determined based on the information and the trigger state of the CSI request field.

In one example, a communication method of a user equipment (UE), comprising receiving a downlink control information (DCI) format, the DCI format comprising a channel state information (CSI) request field set to trigger an aperiodic CSI reporting, and performing, based on the detection of the DCI format, the aperiodic CSI reporting comprising a channel quality indicator (CQI) using a physical uplink shared channel (PUSCH), wherein in a case that cyclic redundancy check (CRC) attached to the DCI format is scrambled by a cell radio network temporary identifier (C-RNTI), a first CQI table is used for interpretation for indices of the CQI, and in a case that CRC attached to the DCI format is scrambled by a first RNTI different from the C-RNTI, a second CQI table is used for interpretation for indices of the CQI.

In one example, a communication method of a user equipment (UE), comprising receiving a radio resource control (RRC) message comprising information used for configuring a correspondence between a trigger state of a channel state information (CSI) request field and a channel quality indicator (CQI) table, receiving a downlink control information (DCI) format, the DCI format comprising a CSI request field set to trigger an aperiodic CSI reporting, and transmitting circuitry configured to perform, based on the detection of the DCI format, the aperiodic CSI reporting comprising a channel quality indicator (CQI) using a physical uplink shared channel (PUSCH), wherein the CQI table used for interpretation for indices of the CQI is determined based on the information and the trigger state of the CSI request field.

In one example, a communication method of a base station apparatus, comprising transmitting a downlink control information (DCI) format, the DCI format comprising a channel state information (CSI) request field set to trigger an aperiodic CSI reporting, and receiving, based on the DCI format, the aperiodic CSI reporting comprising CQI using a physical uplink shared channel (PUSCH), wherein in a case that cyclic redundancy check (CRC) attached to the DCI format is scrambled by a cell radio network temporary identifier (C-RNTI), a first CQI table is used for interpretation for indices of the CQI, and in a case that CRC attached to the DCI format is scrambled by a first RNTI different from the C-RNTI, a second CQI table is used for interpretation for indices of the CQI.

In one example, a communication method of a base station apparatus comprising transmitting a radio resource control (RRC) message comprising information used for configuring a correspondence between a trigger state of a channel state information (CSI) request field and a channel quality indicator (CQI) table, transmitting a downlink control information (DCI) format, the DCI format comprising a CSI request field set to trigger an aperiodic CSI reporting, and receiving, based on the DCI format, the aperiodic CSI reporting comprising CQI using a physical uplink shared channel (PUSCH), wherein the CQI table used for interpretation for indices of the CQI is determined based on the information and the trigger state of the CSI request field.

### BRIEF DESCRIPTION OF DRAWINGS

FIG. 1 is a block diagram illustrating one implementation of one or more base station apparatuses (gNBs) and one or more user equipments (UEs) in which systems and methods for signaling may be implemented.

FIG. 2 shows examples of multiple numerologies.

FIG. 3 is a diagram illustrating one example of a resource grid and resource block.

FIG. 4 shows examples of resource regions.

FIG. 5 illustrates an example of channel state information (CSI) reporting.

FIG. 6 illustrates an example of selecting channel quality indicator (CQI) table(s).

FIG. 7 illustrates various components that may be utilized in a UE.

FIG. 8 illustrates various components that may be utilized in a gNB.

FIG. 9 is a block diagram illustrating one implementation of a UE in which one or more of the systems and/or methods described herein may be implemented.

FIG. 10 is a block diagram illustrating one implementation of a gNB in which one or more of the systems and/or methods described herein may be implemented

FIG. 11 is a block diagram illustrating one implementation of a gNB.

FIG. 12 is a block diagram illustrating one implementation of a UE.

### DESCRIPTION OF EMBODIMENTS

A user equipment (UE) is described. The UE includes receiving circuitry configured to receive a downlink control information (DCI) format. The DCI format includes a channel state information (CSI) request field set to trigger an aperiodic CSI reporting. The UE also includes transmitting circuitry configured to perform, based on the detection of the DCI format. The aperiodic CSI reporting includes a channel quality indicator (CQI) using a physical uplink shared channel (PUSCH). In a case that cyclic redundancy check (CRC) attached to the DCI format is scrambled by a cell radio network temporary identifier (C-RNTI), a first CQI table is used for interpretation for indices of the CQI. In a case that CRC attached to the DCI format is scrambled by a first RNTI different from the C-RNTI, a second CQI table is used for interpretation for indices of the CQI.

The first RNTI may be used for identifying a modulation and coding scheme (MCS) index table from more than one MCS index tables to determine a modulation order and/or a target coding rate.

Another UE is described. The UE includes receiving circuitry configured to receive a radio resource control (RRC) message comprising information used for configuring a correspondence between a trigger state of a CSI request field and a channel quality indicator (CQI) table. The receiving circuitry is also configured to receive a downlink control information (DCI) format. The DCI format includes a CSI request field set to trigger an aperiodic CSI reporting. The UE also includes transmitting circuitry configured to perform, based on the detection of the DCI format, the aperiodic CSI reporting comprising a channel quality indicator (CQI) using a physical uplink shared channel (PUSCH). The CQI table used for interpretation for indices of the CQI is determined based on the information and the trigger state of the CSI request field.

A base station apparatus is also described. The base station apparatus includes transmitting circuitry configured to transmit a DCI format. The DCI format includes a CSI request field set to trigger an aperiodic CSI reporting. The base station apparatus also includes receiving circuitry configured to receive, based on the DCI format, the aperiodic CSI reporting comprising CQI using a PUSCH. In a case that CRC attached to the DCI format is scrambled by C-RNTI, a first CQI table is used for interpretation for indices of the CQI. In a case that CRC attached to the DCI format is scrambled by a first RNTI different from the C-RNTI, a second CQI table is used for interpretation for indices of the CQI.

Another base station apparatus is described. The base station apparatus includes transmitting circuitry configured to transmit a RRC message comprising information used for configuring a correspondence between a trigger state of a CSI request field and a CQI table. The transmitting circuitry is also configured to transmit a DCI format. The DCI format includes a CSI request field set to trigger an aperiodic CSI reporting. The base station apparatus also includes receiving circuitry configured to receive, based on the DCI format, the aperiodic CSI reporting comprising CQI using a PUSCH. The CQI table used for interpretation for indices of the CQI is determined based on the information and the trigger state of the CSI request field.

A communication method of a UE is also described. The method includes receiving a DCI format. The DCI format includes a CSI request field set to trigger an aperiodic CSI reporting. The method also includes performing, based on the detection of the DCI format, the aperiodic CSI reporting comprising a CQI using a PUSCH. In a case that CRC attached to the DCI format is scrambled by C-RNTI, a first CQI table is used for interpretation for indices of the CQI. In a case that CRC attached to the DCI format is scrambled by a first RNTI different from the C-RNTI, a second CQI table is used for interpretation for indices of the CQI.

Another communication method of a UE is also described. The method includes receiving a RRC message including information used for configuring a correspondence between a trigger state of a CSI request field and a CQI table. The method also includes receiving a DCI format, the DCI format including a CSI request field set to trigger an aperiodic CSI reporting. The method further includes transmitting circuitry configured to perform, based on the detection of the DCI format, the aperiodic CSI reporting including a CQI using a PUSCH. The CQI table used for interpretation for indices of the CQI is determined based on the information and the trigger state of the CSI request field.

A communication method of a base station apparatus is also described. The method includes transmitting a DCI format, the DCI format including a CSI request field set to trigger an aperiodic CSI reporting. The method also includes receiving, based on the DCI format, the aperiodic CSI reporting comprising CQI using a PUSCH. In a case that CRC attached to the DCI format is scrambled by C-RNTI, a first CQI table is used for interpretation for indices of the CQI. In a case that CRC attached to the DCI format is scrambled by a first RNTI different from the C-RNTI, a second CQI table is used for interpretation for indices of the CQI.

Another communication method of a base station apparatus is also described. The method includes transmitting a RRC message including information used for configuring a correspondence between a trigger state of a CSI request field and a CQI table. The method also includes transmitting a DCI format, the DCI format including a CSI request field set to trigger an aperiodic CSI reporting. The method further includes receiving, based on the DCI format, the aperiodic CSI reporting comprising CQI using a PUSCH. The CQI table used for interpretation for indices of the CQI is determined based on the information and the trigger state of the CSI request field.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” “gNB” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

The 5th generation communication systems, dubbed NR (New Radio technologies) by 3GPP, envision the use of time/frequency/space resources to allow for services, such as eMBB (enhanced Mobile Broad-Band) transmission, URLLC (Ultra Reliable and Low Latency Communication) transmission, and eMTC (massive Machine Type Communication) transmission. And, in NR, transmissions for different services may be specified (e.g., configured) for one or more bandwidth parts (BWPs) in a serving cell and/or for one or more serving cells. A user equipment (UE) may receive a downlink signal(s) and/or an uplink signal(s) in the BWP(s) of the serving cell and/or the serving cell(s).

In order for the services to use the time, frequency, and/or space resources efficiently, it would be useful to be able to efficiently control downlink and/or uplink transmissions. Therefore, a procedure for efficient control of downlink and/or uplink transmissions should be designed. Accordingly, a detailed design of a procedure for downlink and/or uplink transmissions may be beneficial.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

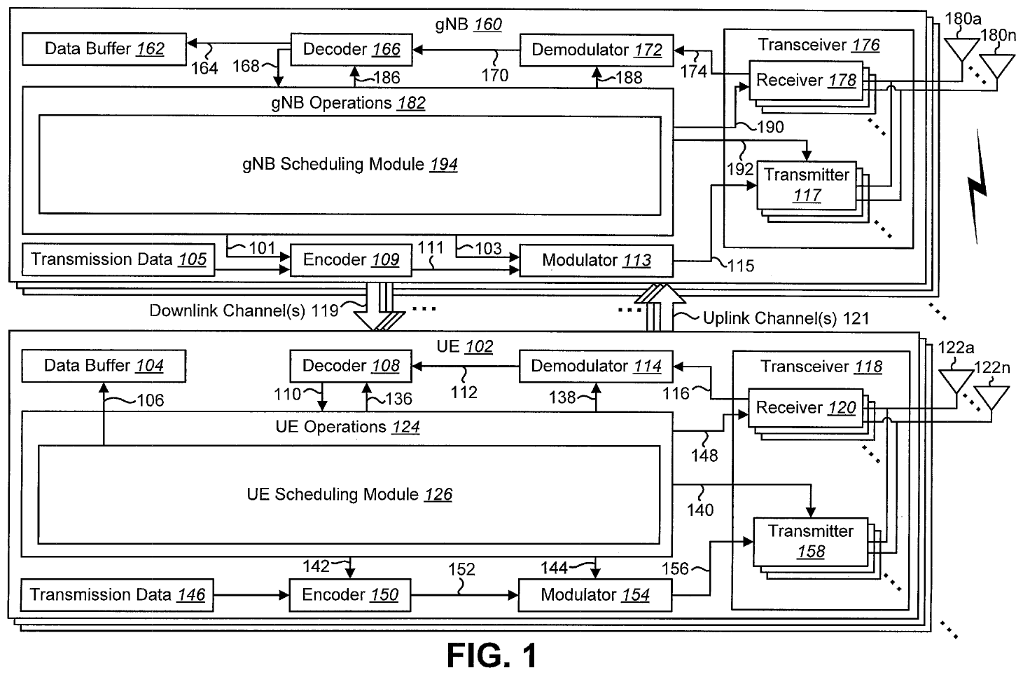

FIG. 1 is a block diagram illustrating one implementation of one or more gNBs 160 and one or more UEs 102 in which systems and methods for signaling may be implemented. The one or more UEs 102 communicate with one or more gNBs 160 using one or more physical antennas 122a-n. For example, a UE 102 transmits electromagnetic signals to the gNB 160 and receives electromagnetic signals from the gNB 160 using the one or more physical antennas 122a-n. The gNB 160 communicates with the UE 102 using one or more physical antennas 180a-n. In some implementations, the term “base station,” “eNB,” and/or “gNB” may refer to and/or may be replaced by the term “Transmission Reception Point (TRP).” For example, the gNB 160 described in connection with FIG. 1 may be a TRP in some implementations.

The UE 102 and the gNB 160 may use one or more channels and/or one or more signals 119, 121 to communicate with each other. For example, the UE 102 may transmit information or data to the gNB 160 using one or more uplink channels 121. Examples of uplink channels 121 include a physical shared channel (e.g., PUSCH (physical uplink shared channel)) and/or a physical control channel (e.g., PUCCH (physical uplink control channel)), etc. The one or more gNBs 160 may also transmit information or data to the one or more UEs 102 using one or more downlink channels 119, for instance. Examples of downlink channels 119 include a physical shared channel (e.g., PDCCH (physical downlink shared channel) and/or a physical control channel (PDCCH (physical downlink control channel)), etc. Other kinds of channels and/or signals may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more physical antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE scheduling module 126.

The UE scheduling module 126 may perform downlink reception(s) and uplink transmission(s). The downlink reception(s) include reception of data, reception of downlink control information, and/or reception of downlink reference signals. Also, the uplink transmissions include transmission of data, transmission of uplink control information, and/or transmission of uplink reference signals.

In a radio communication system, physical channels (uplink physical channels and/or downlink physical channels) may be defined. The physical channels (uplink physical channels and/or downlink physical channels) may be used for transmitting information that is delivered from a higher layer.

For example, in uplink, a PRACH (Physical Random Access Channel) may be defined. In some approaches, the PRACH (e.g., the random access procedure) may be used for an initial access connection establishment procedure, a handover procedure, a connection re-establishment, a timing adjustment (e.g., a synchronization for an uplink transmission, for UL synchronization) and/or for requesting an uplink shared channel (UL-SCH) resource (e.g., the uplink physical shared channel (PSCH) (e.g., PUSCH) resource).

In another example, a PCCH (Physical Control Channel) may be defined. The PCCH may be used to transmit control information. In uplink, PCCH (e.g., Physical Uplink Control Channel (PUCCH)) is used for transmitting uplink control information (UCI). The UCI may include hybrid automatic repeat request (HARQ-ACK), channel state information (CSI) and/or a scheduling request (SR). The HARQ-ACK is used for indicating a positive acknowledgement (ACK) or a negative acknowledgment (NACK) for downlink data (e.g., Transport block(s), Medium Access Control Protocol Data Unit (MAC PDU) and/or Downlink Shared Channel (DL-SCH)). The CSI is used for indicating state of downlink channel (e.g., a downlink signal(s)). For example, the CSI may comprise channel quality indicator (CQI), preceding matrix (PMI). CSI-RS resource indicator (CRI), SS/PBCH block resource indicator (SSBRI), layer indicator (LI), rank indicator (RI), and/or L1-RSRP. Here, the CSI reporting may be periodic and/or aperiodic. Also, the CSI reporting may be performed on the PUSCH and/or the PUCCH. Also, the SR is used for requesting resources of uplink data (e.g., Transport block(s), MAC PDU and/or Uplink Shared Channel (UL-SCH)).

Here, the DL-SCH and/or the UL-SCH may be a transport channel that is used in the MAC layer. Also, a transport block(s) (TB(s)) and/or a MAC PDU may be defined as a unit(s) of the transport channel used in the MAC layer. For example, control, management, and/or process of HARQ may be performed, in the MAC layer, per the transport block. The transport block may be defined as a unit of data delivered from the MAC layer to the physical layer. The MAC layer may deliver the transport block to the physical layer (e.g., the MAC layer delivers the data as the transport block to the physical layer). In the physical layer, the transport block may be mapped to one or more codewords.

In downlink, the PCCH (e.g., physical downlink control channel (PDCCH)) may be used for transmitting downlink control information (DCI). Here, more than one DCI format may be defined (e.g., configured) for DCI transmission on the PCCH. Namely, fields may be defined in the DCI format, and the fields are mapped to the information bits (e.g., DCI bits).

For example, the DCI format 1_0 that is used for scheduling of the PDSCH in the cell may be defined as the DCI format for the downlink. Also, as described herein one or more Radio Network Temporary Identifiers (e.g., the Cell RNTI(s) (C-RNTI(s)), the Configured Scheduling RNTI(s) (CS-RNTI(s)), the first RNTI(s) (e.g., the first CRNTI(s)), the Semi Persistent-CSI-RNTI(s) (the SP-CSI-RNTI(s)), the Paging RNTI(s) (P-RNTI(s)), the System Information RNTI(s) (SI-RNTI(s)), and/or the Random Access RNTI(s) (RA-RNTI(s)) may be used to transmit the DCI format 1_0. Also, the DCI format 1_0 may be monitored (e.g., transmitted, mapped) in the Common Search Space (CSS) and/or the UE Specific Search space (USS). Alternatively, the DCI format 1_0 may be monitored (e.g., transmitted, mapped) in the CSS only.

For example, the DCI format 1_0 may be used for transmitting downlink control information (e.g., DCI). For example, the DCI included in the DCI format 1_0 may be a frequency domain resource assignment (e.g., for the PDSCH). Additionally or alternatively, the DCI included in the DCI format 1_0 may be a time domain resource assignment (e.g., for the PDSCH). Additionally or alternatively, the DCI included in the DCI format 1_0 may be a modulation and coding scheme (e.g., for the PDSCH). Additionally or alternatively, or alternatively, the DCI included in the DCI format 1_0 may be a new data indicator. Additionally or alternatively, the DCI included in the DCI format 1_0 may be a TPC (e.g., Transmission Power Control) command for scheduled PUCCH. Additionally or alternatively, the DCI included in the DCI format 1_0 may be a PUCCH resource indicator. Additionally or alternatively, the DCI included in the DCI format 1_0 may be a timing indicator (e.g., a timing indicator for HARQ transmission for the PDSCH reception). Additionally or alternatively, the DCI included in the DCI format 1_0 may be a CSI request that is used for requesting (e.g., triggering) transmission of the CSI (e.g., CSI reporting (e.g., aperiodic CSI reporting)).

Additionally or alternatively, the DCI format 1_1 that is used for scheduling of the PDSCH in the cell may be defined as the DCI format for the downlink. Additionally or alternatively, the C-RNTI, the CS-RNTI, the SP-CSI-RNTI, and/or the first RNTI may be used to transmit the DCI format 1_1. Additionally or alternatively, the DCI format 1_1 may be monitored (e.g., transmitted and/or mapped) in the CSS and/or the USS.

For example, the DCI format 1_1 may be used for transmitting downlink control information (e.g., DCI). For example, the DCI included in the DCI format 1_1 may be a BWP indicator (e.g., for the PDSCH). Additionally or alternatively, the DCI included in the DCI format 1_1 may be frequency domain resource assignment (e.g., for the PDSCH). Additionally or alternatively, the DCI included in the DCI format 1_1 may be a time domain resource assignment (e.g., for the PDSCH). Additionally or alternatively, the DCI included in the DCI format 1_1 may be a modulation and coding scheme (e.g., for the PDSCH). Additionally or alternatively, the DCI included in the DCI format 1_1 may be a new data indicator. Additionally or alternatively, the DCI included in the DCI format 1_1 may be a TPC command for scheduled PUCCH. Additionally or alternatively, the DCI included in the DCI format 1_1 may be a PUCCH resource indicator. Additionally or alternatively, the DCI included in the DCI format 1_1 may be a timing indicator (e.g., a timing indicator for HARQ transmission for the PDSCH reception). Additionally or alternatively, the DCI included in the DCI format 1_1 may be a SRS request that is used for requesting (e.g., triggering) transmission of the SRS. Additionally or alternatively, the DCI included in the DCI format 1_1 may be a CSI request that is used for requesting (e.g., triggering) transmission of the CSI (e.g., CSI reporting (e.g., aperiodic CSI reporting)).

Additionally or alternatively, the DCI format 0_0 that is used for scheduling of the PUSCH in the cell may be defined as the DCI format for the uplink. Additionally or alternatively, the C-RNTI, the CS-RNTI, the first RNTI, the SP-CSI-RNTI, and/or the Temporary C-RNTI may be used to transmit the DCI format 0_0. Additionally or alternatively, the DCI format 0_0 may be monitored (e.g., transmitted, mapped) in the CSS and/or the USS. Alternatively, the DCI format 0_0 may be monitored (e.g., transmitted, mapped) in the CSS only.

For example, the DCI format 0_0 may be used for transmitting downlink control information (e.g., DCI). For example, the DCI included in the DCI format 0_0 may be a frequency domain resource assignment (e.g., for the PUSCH). Additionally or alternatively, the DCI included in the DCI format 0_0 may be a time domain resource assignment (e.g., for the PUSCH). Additionally or alternatively, the DCI included in the DCI format 0_0 may be a modulation and coding scheme (e.g., for the PUSCH). Additionally or alternatively, the DCI included in the DCI format 0_0 may be a new data indicator. Additionally or alternatively, the DCI included in the DCI format 0_0 may be a redundancy version. Additionally or alternatively, the DCI included in the DCI format 0_0 may be a TPC command for scheduled PUSCH. Additionally or alternatively, the DCI included in the DCI format 0_0 may be a CSI request that is used for requesting (e.g., triggering) transmission of the CSI (CSI reporting (e.g., aperiodic CSI reporting)).

Additionally or alternatively, a DCI format 0_1 that is used for scheduling of the PUSCH in the cell may be defined as the DCI format for the uplink. Additionally or alternatively, the C-RNTI, the CS-RNTI, the SP-CSI-RNTI, and/or the first RNTI may be used to transmit the DCI format 0_1. Additionally or alternatively, the DCI format 0_1 may be monitored (e.g., transmitted, mapped) in the CSS and/or the USS.

For example, the DCI format 0_1 may be used for transmitting downlink control information (e.g., DCI). For example, the DCI included in the DCI format 0_1 may be a BWP indicator (e.g., for the PUSCH). Additionally or alternatively, the DCI included in the DCI format 0_1 may be a frequency domain resource assignment (e.g., for the PUSCH). Additionally or alternatively, the DCI included in the DCI format 0_1 may be a time domain resource assignment (e.g., for the PUSCH). Additionally or alternatively, the DCI included in the DCI format 0_1 may be a modulation and coding scheme (e.g., for the PUSCH). Additionally or alternatively, the DCI included in the DCI format 0_1 may be a new data indicator. Additionally or alternatively, the DCI included in the DCI format 0_1 may be a TPC command for scheduled PUSCH. Additionally or alternatively, the DCI included in the DCI format 0_1 may be a PUCCH resource indicator. Additionally or alternatively, the DCI included in the DCI format 0_1 may be a SRS request that is used for requesting (e.g., triggering) transmission of the SRS. Additionally or alternatively, the DCI included in the DCI format 0_1 may be a CSI request that is used for requesting (e.g., triggering) transmission of the CSI (e.g., CSI reporting (e.g., aperiodic CSI reporting)).

Additionally or alternatively, the DCI format A that is used for scheduling of the PDSCH in the cell may be defined as the DCI format for the downlink. Here, the DCI format A described herein may be assumed to be included in the compact DCI format(s) for the downlink in some implementations for the sake of simplifying description. Additionally or alternatively, as described herein, the C-RNTI, the CS-RNTI, the first RNTI, the P-RNTI, the SI-RNTI, the SP-CSI-RNTI, and/or the RA-RNTI may be used to transmit the DCI format A. Additionally or alternatively, the DCI format A may be monitored (e.g., transmitted, mapped) in the CSS and/or the USS. Alternatively, the DCI format A may be monitored (e.g., transmitted, mapped) in the CSS only. Alternatively, the DCI format A may be monitored (e.g., transmitted, mapped) in the CSS only.

For example, the DCI format A may be used for transmitting downlink control information (e.g., DCI). For example, the DCI included in the DCI format A may be a frequency domain resource assignment (e.g., for the PDSCH). Additionally or alternatively, the DCI included in the DCI format A may be a time domain resource assignment (e.g., for the PDSCH). Additionally or alternatively, the DCI included in the DCI format A may be a modulation and coding scheme (e.g., for the PDSCH). Additionally or alternatively, the DCI included in the DCI format A may be a new data indicator. Additionally or alternatively, the DCI included in the DCI format A may be a TPC (e.g., Transmission Power Control) command for scheduled PUCCH. Additionally or alternatively, the DCI included in the DCI format A may be a PUCCH resource indicator. Additionally or alternatively, the DCI included in the DCI format A may be a timing indicator (e.g., a timing indicator for HARQ transmission for the PDSCH reception). Additionally or alternatively, the DCI included in the DCI format A may be a CSI request that is used for requesting (e.g., triggering) transmission of the CSI (e.g., CSI reporting (e.g., aperiodic CSI reporting)).

Additionally or alternatively, the DCI format B that is used for scheduling of the PUSCH in the cell may be defined as the DCI format for the uplink. Here, the DCI format B described herein may be assumed to be included in the compact DCI format for the uplink in some implementations for the sake of simplifying description. Additionally or alternatively, the C-RNTI, the CS-RNTI, the first RNTI, the SP-CSI-RNTI, and/or the Temporary C-RNTI may be used to transmit the DCI format B. Additionally or alternatively, the DCI format B may be monitored (e.g., transmitted, mapped) in the CSS and/or the USS. Alternatively, the DCI format B may be monitored (e.g., transmitted, mapped) in the CSS only. Alternatively, the DCI format B may be monitored (e.g., transmitted, mapped) in the USS only.

For example, the DCI format B may be used for transmitting downlink control information (e.g., DCI). For example, the DCI included in the DCI format B may be a frequency domain resource assignment (e.g., for the PUSCH). Additionally or alternatively, the DCI included in the DCI format B may be a time domain resource assignment (e.g., for the PUSCH). Additionally or alternatively, the DCI included in the DCI format B may be a modulation and coding scheme (e.g., for the PUSCH). Additionally or alternatively, the DCI included in the DCI format B may be a new data indicator. Additionally or alternatively, the DCI included in the DCI format B may be a redundancy version. Additionally or alternatively, the DCI included in the DCI format B may be a TPC command for scheduled PUSCH. Additionally or alternatively, the DCI included in the DCI format B may be a CSI request that is used for requesting (e.g., triggering) transmission of the CSI (e.g., CSI reporting (e.g., aperiodic CSI reporting)).

Additionally or alternatively, in a case that the DCI format 1_0 is received (e.g., based on the detection of the DCI format 1_0), the UE 102 may receive (e.g., decode, detect) the scheduled PDSCH. Additionally or alternatively, in a case that the DCI format 1_1 is received (e.g., based on the detection of the DCI format 1_1), the UE 102 may receive (e.g., decode, detect) the scheduled PDSCH. Additionally or alternatively, in a case that the DCI format A is received (e.g., based on the detection of the DCI format A), the UE 102 may receive (e.g., decode, detect) the scheduled PDSCH.

Additionally or alternatively, in a case that the DCI format 0_0 is received (e.g., based on the detection of the DCI format 0_0), the UE 102 may perform the PUSCH transmission. Additionally or alternatively, in a case that the DCI format 0_1 is received (e.g., based on the detection of the DCI format 0_1), the UE 102 may perform the PUSCH transmission. Additionally or alternatively, in a case that the DCI format B is received (e.g., based on the detection of the DCI format B), the UE 102 may perform the PUSCH transmission. Here, the UE 102 may perform the CSI reporting (e.g., the aperiodic CSI reporting) using the PUSCH (i.e., the scheduled PUSCH), based on the detection of the DCI format 0_0 including the CSI request (i.e., a CSI request field) set to request (e.g., trigger) the CSI report (e.g., the aperiodic CSI report). Additionally or alternatively, the UE 102 may perform the CSI reporting (e.g., the aperiodic CSI reporting) using the PUSCH, based on the detection of the DCI format 0_1 including the CSI request set to request the CSI report (e.g., the aperiodic CSI report). Additionally or alternatively, the UE 102 may perform the CSI reporting (e.g., the aperiodic CSI reporting) using the PUSCH, based on the detection of the DCI format A including the CSI request set to request (e.g., trigger) the CSI report (e.g., the aperiodic CSI report).

Here, as described above, a RNTI(s) (e.g., a Radio Network Temporary Identifier(s)) assigned to the UE 102 may be used for transmission of DCI (e.g., the DCI format(s), DL control channel(s) (e.g., the PDCCH(s)). Namely, the gNB 160 may transmit, (e.g., by using the RRC message), information used for configuring (e.g., assigning) the RNTI(s) to the UE 102. For example, CRC (Cyclic Redundancy Check) parity bits (also referred to simply as CRC), which are generated based on DCI, are attached to DCI, and, after attachment, the CRC parity bits are scrambled by the RNTI(s). The UE 102 may attempt to decode (e.g., blind decoding, monitor, detect) DCI to which the CRC parity bits scrambled by the RNTI(s) are attached. For example, the UE 102 detects DL control channel (e.g., the PDCCH, the DCI, the DCI format(s)) based on the blind decoding. That is, the UE 102 may decode the DL control channel(s) with the CRC scrambled by the RNTI(s). In other words, the UE 102 may monitor the DL control channel(s) with the RNTI(s). Additionally or alternatively, as described herein, the UE 102 may detect the DCI format(s) in a USS (e.g., the control channel resource set (CORESET) of a USS (e.g., a UE-specific search space)) and/or a CSS (e.g., the CORESET of a CSS (e.g., a common search space, a UE-common search space)). For example, the UE 102 may detect the DCI format(s) with the RNTI(s).

Here, the RNTI(s) may include the C-RNTI(s) (Cell-RNTI(s)), the CS-RNTI(s) (Configured Scheduling C-RNTI(s)), the first RNTI(s), the SP-CSI-RNTI(s) (Semi Persistent CSI-RNTI(s)), the SI-RNTI(s) (System Information RNTI(s)), the PRNTI(s) (Paging RNTI(s)), the RA-RNTI(s) (Random Access-RNTI(s)), and/or the Temporary C-RNTI(s). As described above, for example, the C-RNTI(s), the CS-RNTI(s), the first RNTI(s), the SP-CSI-RNTI(s), the SI-RNTI(s), the P-RNTI(s), and/or the RA-RNTI(s) may be used for the DCI format(s) for the downlink. Also, the CRNTI(s), the CS RNTI(s), the SP-CSI-RNTI(s), the first RNTI(s), and/or the Temporary C-RNTI(s) may be used for the DCI format(s) for the uplink. Here, the first RNTI(s) is a different RNTI from the C-RNTI(s), the CS-RNTI(s), the SP-CSI-RNTI(s), the P-RNTI(s), the SI-RNTI(s), the temporary C-RNTI(s), and/or the RA-RNTI(s).

For example, the C-RNTI(s) and/or the first RNTI(s) may be a unique identification used for identifying a RRC connection and/or scheduling. Additionally or alternatively, the SPS C-RNTI(s) may be a unique identification used for semi-persistent scheduling. Additionally or alternatively, the CS-RNTI(s) may be a unique identification used for scheduling of transmission based on a configured grant. Additionally or alternatively, the first RNTI(s) may be a unique identification used for identifying the DCI format(s) E and/or the DCI format(s) F. For example, the UE 102 may identify the DCI format(s) E and/or the DCI format(s) F based on a detection of the first RNTI(s). For example, if the UE 102 detects the first RNTI(s), the UE 102 may recognize the monitored DCI format(s) as the DCI format(s) E and/or the DCI format(s) F. Additionally or alternatively, the SP-CSI-RNTI(s) may be used for activation of Semi-Persistent CSI reporting (e.g., SP CSI reporting) on the PUSCH and/or the PUCCH. For example, the UE 102 perform the SP CSI reporting on the PUSCH and/or the PUCCH, based on the detection of the DCI format(s) (e.g., the DCI format(s) for the uplink) with CRC scrambled by the SP-CSI-RNTI.

Additionally or alternatively, the RNTI(s) (e.g., the C-RNTI(s), the SP-CSI-RNTI(s), and/or the first RNTI) may be used for identifying CQI table(s) and/or MCS table(s) 0. For example, in a case that more than one CQI tables (e.g., 3 tables) are configured (e.g., defined), the UE 102 may select (e.g., determine, use), based on the detection of the RNTI(s) (e.g., the C-RNTI, the SP-CSI-RNTI, and/or the first RNTI), one of the more than one CQI tables (e.g., select one CQI table for interpretation(s) for CQI indices). Namely, the CQI indices and/or the interpretation for the CSI indices may be given by the CQI table(s) based on the detected RNTI(s) (e.g., the C-RNTI(s), the SP-CSI RNTI, and/or the first RNTI). Here, for example, the more than one CQI tables may include a table (e.g., 4-bit CQI table, a first CQI table) for reporting CQI based on QPSK, 16QAM and 64QAM. Also, the more than one CQI tables may include a table (e.g., 4-bit CQI table, a second CQI table) for reporting CQI based on QPSK, 16QAM, 64QAM and 256QAM. Also, the more than one CQI tables may include a table (e.g., 4-bit CQI table, a third CQI table) for reporting CQI based on QPSK, 16QAM.

For example, in a case that the UE 102 detects the DCI format(s) to which the CRC scrambled by the C-RNTI and/or the SP-CSI-RNTI is attached, the UE 102 may use the first CQI table for interpretation for the CQI indices. Additionally or alternatively, in a case that the UE 102 detects the DCI format(s) to which the CRC scrambled by the first RNTI is attached, the UE 102 may use the third CQI table for interpretation for the CQI indices. Namely, at least, the third RNTI may be used for identifying the CQI table(s) (e.g., the first CQI table, the second CQI table, and/or the third CQI table) for interpretation for the CQI indices.

Also, for example, in a case that more than one MCS tables (e.g., 3 tables) are configured (e.g., defined), the UE 102 may select (e.g., determine, use), based on the detection of the RNTI(s) (e.g., the C-RNTI, the SP-CSI-RNTI, and/or the first RNTI), one of the more than one MCS tables (e.g., select one MCS table to determine a modulation order and/or a target code rate used in the PUSCH). Namely, the modulation code and/or the target code rate may be given by the MCS table(s) based on the detected RNTI(s) (e.g., the C-RNTI(s), the SP-CSI RNTI, and/or the first RNTI). Here, for example, the more than one MCS tables may include a table (e.g., 5-bit MCS table, a first MCS table) for reporting CQI based on QPSK, 16QAM and 64QAM. Also, the more than one CQI tables may include a MCS index table (e.g., 5-bit MCS table, a second MCS table) for PUSCH with transform precoding and/or 64 QAM.

For example, in a case that the UE 102 detects the DCI format(s) to which the CRC scrambled by the C-RNTI and/or the SP-CSI RNTI is attached, the UE 102 may use the first MCS table to determine the modulation order and/or the target code rate. Additionally or alternatively, in a case that the UE 102 detects the DCI format(s) to which the CRC scrambled by the first RNTI is attached, the UE 102 may use the third MCS table to determine the modulation order and/or the target code rate. Namely, at least, the third RNTI may be used for identifying the MCS table(s) (e.g., the first MCS table, the second MCS table, and/or the third MCS table) to determine the modulation order and/or the target code rate.

Additionally or alternatively, the SI-RNTI may be used for identifying system information (SI) (e.g., an SI message) mapped on the BCCH and dynamically carried on DL-SCH. Additionally or alternatively, the SI-RNTI may be used for broadcasting of SI. Additionally or alternatively, the P-RNTI may be used for transmission of paging and/or SI change notification. Additionally or alternatively, the RA-RNTI may be an identification used for the random access procedure (e.g., Msg.2 transmission). Additionally or alternatively, the Temporary C-RNTI may be used for the random access procedure (e.g., scheduling of Msg.3 (re)transmission (e.g., Msg.3 PUSCH (re)transmission)).

Additionally or alternatively, for example, PSCH may be defined. For example, in a case that the downlink PSCH resource (e.g., the PDSCH, the PDSCH resource) is scheduled by using the DCI format(s), the UE 102 may receive the downlink data, on the scheduled downlink PSCH resource (e.g., the PDSCH, the PDSCH resource). Additionally or alternatively, in a case that the uplink PSCH resource (e.g., the PUSCH, the PUSCH resource) is scheduled by using the DCI format(s), the UE 102 transmits the uplink data, on the scheduled uplink PSCH resource (e.g., the PUSCH, the PUSCH resource). For example, the downlink PSCH may be used to transmit the downlink data (e.g., DL-SCH(s), a downlink transport block(s)). Additionally or alternatively, the uplink PSCH may be used to transmit the uplink data (e.g., UL-SCH(s), an uplink transport block(s)).

Furthermore, the downlink PSCH (e.g., the PDSCH) and/or the uplink PSCH (e.g., the PUSCH) may be used to transmit information of a higher layer (e.g., a radio resource control (RRC)) layer, and/or a MAC layer). For example, the downlink PSCH (e.g., from the gNB 160 to the UE 102) and/or the uplink PSCH (e.g., from the UE 102 to the gNB 160) may be used to transmit a RRC message (a RRC signal). Additionally or alternatively, the downlink PSCH (e.g., from the gNB 160 to the UE 102) and/or the uplink PSCH (e.g., from the UE 102 to the gNB 160) may be used to transmit a MAC control element (a MAC CE). Here, the RRC message that is transmitted from the gNB 160 in downlink may be common to multiple UEs 102 (and/or multiple serving cells) within a cell (referred as a common RRC message). Additionally or alternatively, the RRC message that is transmitted from the gNB 160 may be dedicated to a certain UE 102 (and/or a serving cell (e.g., a serving cell-dedicated)) (referred as a dedicated RRC message). The RRC message and/or the MAC CE are also referred to as a higher layer signal. For example, the RRC message may include the master information block (MIB) (e.g., PBCH), the system information block (SIB) (e.g., the SIB type 2), and/or the dedicated RRC message. For instance, a configuration by using the RRC message may include a configuration by using the PBCH (e.g., the MIB), the PDSCH (e.g., the SIB type 2), and/or the dedicated RRC message.

In some approaches, the downlink PSCH (e.g., the PDSCH) may be used for transmitting (e.g., notifying, specifying, identifying, etc.) a random access response (e.g., a message 2 (Msg.2)). For example, the downlink PSCH (e.g., the PDSCH) for the random access response may be scheduled by using the downlink physical channel (PCH) (e.g., the PDCCH, the DCI format(s) (e.g., the DCI format 1_0, and/or the DCI format 1_1)) with the RA-RNTI. For instance, the random access response grant included in the random access response may be used for scheduling of the uplink PSCH (e.g., the PUSCH, a message 3 (Msg.3) in the random access procedure (e.g., the non-contention based random access procedure (i.e., a contention free random access procedure), and/or the contention based random access procedure)). The random access response grant may be delivered from the higher layer (e.g., the MAC layer) to the physical layer. Namely, in the Msg.2 (e.g., the random access response), the DCI format(s) with CRC scrambled by the RA-RNTI may be used for scheduling of the PDSCH (e.g., the PDSCH that includes DL-SCH transport block). And, the PDSCH may include the random access response grant used for scheduling of the PUSCH (e.g., transmission on UL-SCH, transmission of UL-SCH transport block). Namely, the random access response grant may be transmitted on the PDSCH.

For example, the random access response grant may include information used for indicating whether a frequency hopping is applied Msg.3 PUSCH transmission or not. Additionally or alternatively, the random access response grant may include information used for a frequency domain resource assignment (e.g., for the Msg.3 PUSCH). Additionally or alternatively, the random access response grant may include information used for a time domain resource assignment (e.g., for the Msg.3 PUSCH). Additionally or alternatively, the random access response grant may include information used for indicating a modulation and coding scheme (e.g., for the Msg.3 PUSCH). Additionally or alternatively, the random access response grant may include information used for indicating a TPC command for the Msg.3 PUSCH. Additionally or alternatively, the random access response grant may include information (e.g., a CSI request) used for requesting (e.g., triggering) transmission of the CSI (e.g., CSI reporting (e.g., aperiodic CSI reporting)). For example, in the non-contention based random access procedure, the CSI request (i.e., the CSI request field) is interpreted to determine the aperiodic CSI report is included in the corresponding PUSCH transmission. Here, in the contention based random access procedure, the CSI request (i.e., the CSI request field) may be reserve. Namely, only in the non-contention based random access procedure, the UE 102 may perform the aperiodic CSI reporting based on the detection of the random access response grant including the CSI request requesting (e.g., triggering) the transmission of the aperiodic CSI reporting.

In some approaches, a PBCH (physical broadcast channel, (e.g., primary PBCH)) may be defined. For example, the PBCH may be used for broadcasting the MIB (master information block). For instance, the MIB may be used by multiple UEs 102 and may include system information transmitted on the BCH (broadcast channel). Additionally or alternatively, the MIB may include information (e.g., an information block) for configuring a secondary PBCH. Furthermore, the MIB may include information (e.g., an information block) for configuring the downlink PSCH (e.g., PDSCH). For example, the PBCH (e.g., MIB) may be used for carrying, at least, information indicating a SFN (system frame number).

Here, the system information may be divided into the MIB and a number of SIB(s) (system information block(s)). The MIB may include a limited number of most essential and/or most frequently transmitted information (e.g., parameter(s)) that are needed to acquire other information from the cell. For example, the PBCH (e.g., MIB) may include minimum system information. Additionally or alternatively, the SIB(s) may be carried in a system information message. For example, the SIB(s) may be transmitted on the secondary PBCH and/or the downlink PSCH (e.g., the PDSCH). The SIB(s) (e.g., System Information Block Type 2) may include remaining minimum system information (e.g., RMSI). For example, the SIB(s) (e.g., System Information Block Type 2) may contain radio resource configuration information that is common for multiple UEs 102.

In some approaches, in downlink, a SS (Synchronization Signal) may be defined. The SS may be used for acquiring time and/or frequency synchronization with a cell. Additionally or alternatively, the SS may be used for detecting a physical layer cell ID of the cell. Here, a cell search may a procedure by which the UE 102 acquires the time and/or frequency synchronization with the cell. Additionally or alternatively, the cell search may be a procedure by which the UE 102 detects the physical layer cell ID. The SS may include a PSS (Primary Synchronization Signal). Additionally or alternatively, the SS may include a SSS (Secondary Synchronization Signal). Here, an SS/PBCH block(s) may be defined (e.g., specified). For example, in the time domain, an SS/PBCH block may consist of 4 OFDN symbols, numbered in increasing order from 0 to 3 within the SS/PBCH block, where the PSS, the SSS and the PBCH, DM-RS associated with the PBCH are mapped to different symbols. For example, the SS/PBCH block may consist of the PSS, the SSS, the PBCH, and/or the DM-RS associated with the PBCH. Here, the PBCH may be used for carrying information identifying SF number (System Frame number), an OFDM symbol index, a slot index in a radio frame and/or a radio frame number. Here, the SS/PBCH block(s) described herein may be assumed to be included in a SS block(s) in some implementations for the sake of simplifying description.

In the radio communication for uplink, UL RS(s) may be used as uplink physical signal(s). The uplink physical signal may not be used to transmit information that is provided from the higher layer, but is used by a physical layer. For example, the UL RS(s) may include the demodulation reference signal(s), the UE-specific reference signal(s), the sounding reference signal(s) (the SRS(s)) and/or the beam-specific reference signal(s). The demodulation reference signal(s) (e.g., DM-RS) may include the demodulation reference signal(s) associated with transmission of the uplink physical channel (e.g., the PUSCH and/or the PUCCH).

Additionally or alternatively, the UE-specific reference signal(s) may include reference signal(s) associated with transmission of uplink physical channel (e.g., the PUSCH and/or the PUCCH). For example, the demodulation reference signal(s) and/or the UE-specific reference signal(s) may be a valid reference for demodulation of uplink physical channel only if the uplink physical channel transmission is associated with the corresponding antenna port. The gNB 160 may use the demodulation reference signal(s) and/or the UE-specific reference signal(s) to perform (re)configuration of the uplink physical channels. The sounding reference signal may be used to measure an uplink channel state.

Additionally or alternatively, in the radio communication for downlink, DL RS(s) may be used as downlink physical signal(s). The downlink physical signal may not be used to transmit information that is provided from the higher layer, but is used by a physical layer. For example, the DL RS(s) may include the cell-specific reference signal(s), the UE-specific reference signal(s), the demodulation reference signal(s), and/or the channel state information reference signal(s) (the CSI-RS(s)). The UE-specific reference signal may include the UE-specific reference signal(s) associated with transmission of the downlink physical channel (e.g., the PDSCH and/or the PDCCH). Additionally or alternatively, the demodulation reference signal(s) may include the demodulation reference signal(s) associated with transmission of the downlink physical channel (e.g., the PDSCH and/or the PDCCH). Additionally or alternatively, the CSI-RS may include Non-zero power Channel State Information-Reference signal(s) (NZP CSI-RS), and/or Zero power Channel State Information-Reference signal (ZP CSI-RS).

Here, the downlink physical channel(s) and/or the downlink physical signal(s) described herein may be assumed to be included in a downlink signal (e.g., a DL signal(s)) in some implementations for the sake of simple descriptions. Additionally or alternatively, the uplink physical channel(s) and/or the uplink physical signal(s) described herein may be assumed to be included in an uplink signal (i.e. an UL signal(s)) in some implementations for the sake of simple descriptions.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the gNB 160.

The UE operations module 124 may provide information 136 to the decoder 108. For example, the UE operations module 124 may inform the decoder 108 of an anticipated encoding for transmissions from the gNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the gNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the gNB 160. For instance, the one or more transmitters 158 may transmit during a UL subframe. The one or more transmitters 158 may upconvert and transmit the modulated signal(s) 156 to one or more gNBs 160.

Each of the one or more gNBs 160 may include one or more transceivers 176, one or more demodulators 172, one or more decoders 166, one or more encoders 109, one or more modulators 113, a data buffer 162 and a gNB operations module 182. For example, one or more reception and/or transmission paths may be implemented in a gNB 160. For convenience, only a single transceiver 176, decoder 166, demodulator 172, encoder 109 and modulator 113 are illustrated in the gNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more physical antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more physical antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the gNB operations module 182 to perform one or more operations.

In general, the gNB operations module 182 may enable the gNB 160 to communicate with the one or more UEs 102. The gNB operations module 182 may include one or more of a gNB scheduling module 194. The gNB scheduling module 194 may perform scheduling of downlink and/or uplink transmissions as described herein.

The gNB operations module 182 may provide information 188 to the demodulator 172. For example, the gNB operations module 182 may inform the demodulator 172 of a modulation pattern anticipated for transmissions from the UE(s) 102.

The gNB operations module 182 may provide information 186 to the decoder 166. For example, the gNB operations module 182 may inform the decoder 166 of an anticipated encoding for transmissions from the UE(s) 102.

The gNB operations module 182 may provide information 101 to the encoder 109. The information 101 may include data to be encoded and/or instructions for encoding. For example, the gNB operations module 182 may instruct the encoder 109 to encode information 101, including transmission data 105.

The encoder 109 may encode transmission data 105 and/or other information included in the information 101 provided by the gNB operations module 182. For example, encoding the data 105 and/or other information included in the information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The gNB operations module 182 may provide information 103 to the modulator 113. This information 103 may include instructions for the modulator 113. For example, the gNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The gNB operations module 182 may provide information 192 to the one or more transmitters 117. This information 192 may include instructions for the one or more transmitters 117. For example, the gNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a DL subframe may be transmitted from the gNB 160 to one or more UEs 102 and that a UL subframe may be transmitted from one or more UEs 102 to the gNB 160. Furthermore, both the gNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

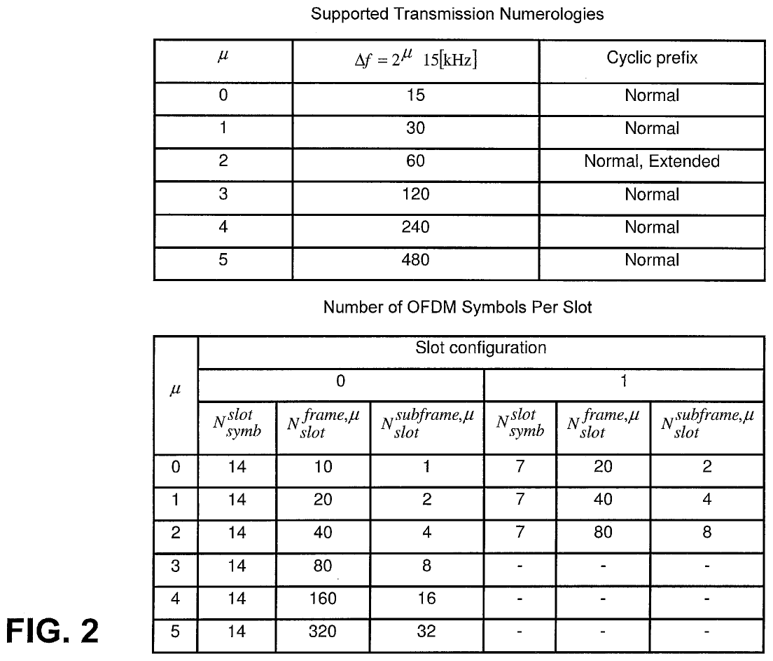

FIG. 2 shows examples of multiple numerologies. As shown in FIG. 2, multiple numerologies (e.g., multiple subcarrier spacing) may be supported. For example, μ (e.g., a subcarrier space configuration) and a cyclic prefix (e.g., the μ and the cyclic prefix for a carrier bandwidth part) may be configured by higher layer parameters (e.g., a RRC message) for the downlink and/or the uplink. Here, 15 kHz may be a reference numerology. For example, an RE of the reference numerology may be defined with a subcarrier spacing of 15 kHz in a frequency domain and 2048 Ts+CP length (e.g. 160 Ts or 144 Ts) in a time domain, where Ts denotes a baseband sampling time unit defined as 1/(15000*2048) seconds.

Additionally or alternatively, a number of OFDM symbol(s) per slot (N_{symb}^{slot}) may be determined based on the μ (e.g., the subcarrier space configuration). Here, for example, a slot configuration 0 (e.g., the number of OFDM symbols per slot may be 14) and/or a slot configuration (e.g., the number of OFDM symbols per slot may be 7) may be defined.

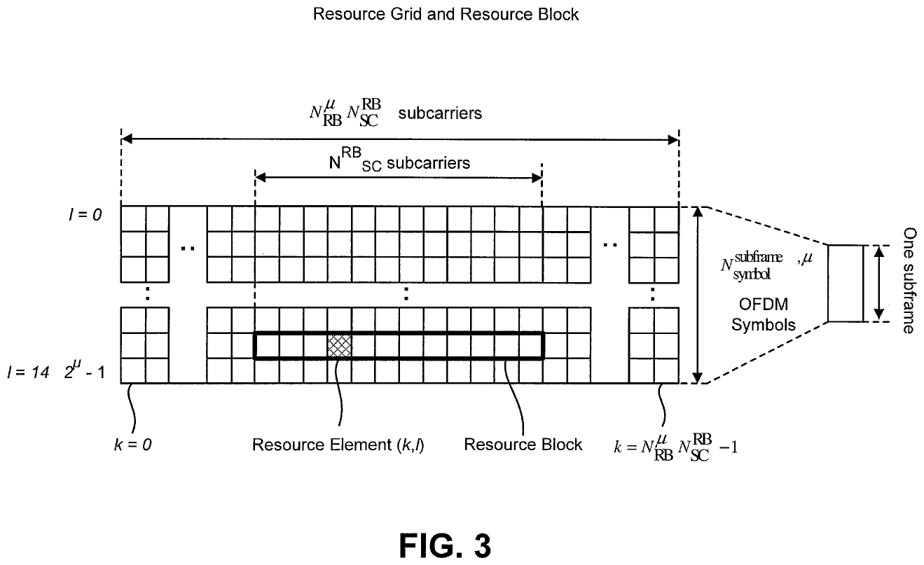

FIG. 3 is a diagram illustrating one example of a resource grid and resource block (e.g., for the downlink and/or the uplink). The resource grid illustrated in FIG. 3 may be utilized in some implementations of the systems and methods disclosed herein.

In FIG. 3, one subframe may include N_{symbol}^{subframe,μ} symbols. Additionally or alternatively, a resource block may include a number of resource elements (RE). Here, in the downlink, the OFDM access scheme with cyclic prefix (CP) may be employed, which may be also referred to as CP-OFDM. A downlink radio frame may include multiple pairs of downlink resource blocks (RBs) which is also referred to as physical resource blocks (PRBs). The downlink RB pair is a unit for assigning downlink radio resources, defined by a predetermined bandwidth (RB bandwidth) and a time slot. The downlink RB pair may include two downlink RBs that are continuous in the time domain Additionally or alternatively, the downlink RB may include twelve sub-carriers in frequency domain and seven (for normal CP) or six (for extended CP) OFDM symbols in time domain. A region defined by one sub-carrier in frequency domain and one OFDM symbol in time domain is referred to as a resource element (RE) and is uniquely identified by the index pair (k, l), where k and l are indices in the frequency and time domains, respectively.

Additionally or alternatively, in the uplink, in addition to CP-OFDM, a Single-Carrier Frequency Division Multiple Access (SC-FDMA) access scheme may be employed, which is also referred to as Discrete Fourier Transform-Spreading OFDM (DFT-S-OFDM). An uplink radio frame may include multiple pairs of uplink resource blocks. The uplink RB pair is a unit for assigning uplink radio resources, defined by a predetermined bandwidth (RB bandwidth) and a time slot. The uplink RB pair may include two uplink RBs that are continuous in the time domain. The uplink RB may include twelve sub-carriers in frequency domain and seven (for normal CP) or six (for extended CP) OFDM/DFT-S-OFDM symbols in time domain. A region defined by one sub-carrier in the frequency domain and one OFDM/DFT-S-OFDM symbol in the time domain is referred to as a resource element (RE) and is uniquely identified by the index pair (k, l) in a slot, where k and l are indices in the frequency and time domains respectively.

Each element the resource grid (e.g., antenna port p) and the subcarrier configuration μ is called a resource element and is uniquely identified by the index pair (k, l) where k=0, . . . , N_{RB}^{μ}N_{SC}^{RB}−1 is the index in the frequency domain and l refers to the symbol position in the time domain. The resource element (k, l) on the antenna port p and the subcarrier spacing configuration μ is denoted (k, l)ₚ, μ. The physical resource block is defined as N_{SC}^{RB}=12 consecutive subcarriers in the frequency domain. The physical resource blocks are numbered from 0 to N_{RB}^{μ}−1 the frequency domain. The relation between the physical resource block number ⁿPRB in the frequency domain and the resource element (k, l) is given by

$${n}_{PRB} = ⌊ \frac{k}{{N}_{SC}^{RB}} ⌋ .$$

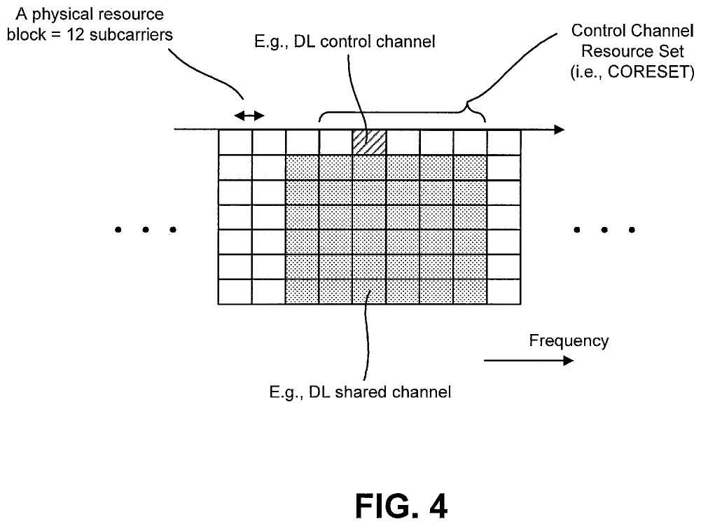

FIG. 4 shows examples of resource regions (e.g., resource region of the downlink). One or more sets of PRB(s) (e.g., a control resource set (e.g., CORESET)) may be configured for DL control channel monitoring (e.g., the PDCCH monitoring). For example, the control resource set (e.g., the CORESET) is, in the frequency domain and/or the time domain, a set of PRBs within which the UE 102 attempts to decode the DCI (e.g., the DCI format(s), the PDCCH(s)), where the PRBs may or may not be frequency contiguous and/or time contiguous, a UE 102 may be configured with one or more control resource sets (e.g., the CORESETs) and one DCI message may be mapped within one control resource set. In the frequency-domain, a PRB is the resource unit size (which may or may not include DM-RS) for the DL control channel. A DL shared channel may start at a later OFDM symbol than the one(s) which carries the detected DL control channel. Alternatively, the DL shared channel may start at (or earlier than) an OFDM symbol than the last OFDM symbol which carries the detected DL control channel. In other words, dynamic reuse of at least part of resources in the control resource sets for data for the same or a different UE 102, at least in the frequency domain may be supported.

The UE 102 may monitor a set of candidate(s) of the DL control channel(s) (e.g., PDCCH) in one or more control resource sets (e.g., the CORESET(s)) on the active DL BWP on each activated serving cell according to corresponding search space sets. Here, the candidate(s) of the DL control channel(s) may be candidates for which the DL control channel(s) may possibly be mapped, assigned, and/or transmitted. For example, a candidate of the DL control channel(s) is composed of one or more control channel elements (CCEs). Here, the term “monitor” may imply that the UE 102 attempts to decode each DL control channel(s) (e.g., the PDCCH(s), the PDCCH candidate(s)) according to the monitored DCI format(s).

The set of candidate(s) of the DL control channel(s) (e.g., the PDCCH(s), the CORESET(s) of the PDCCH(s)) for the UE 102 to monitor may be defined in terms of a search space set(s) (e.g., a search space(s), PDCCH search space(s)). For example, the search space(s) is a set of resource(s) (e.g., CORESET(s)) that may possibly be used for transmission of the PDCCH(s). The UE 102 may monitor the set of PDCCH candidate(s) according to the search space(s). The search space set(s) may comprise a common search space(s) (CSS(s), UE-common search space(s)) and/or a user equipment-specific search space(s) (USS, UE-specific search space(s)).

Here, the CSS and/or the USS are defined (or set, configured) in a region(s) of DL control channel(s) (e.g., the DL control channel monitoring regions, CORESET). For example, the CSS may be used for transmission of DCI to a plurality of the UEs 102. That is, the CSS may be defined by a resource common to a plurality of the UEs 102. For example, a Type0-PDCCH common search space may be defined for the DCI format(s) with CRC scrambled by the SI-RNTI. Additionally or alternatively, a Type1-PDCCH common search space may be defined for the DCI format(s) with CRC scrambled by the RA-RNTI, the Temporary C-RNTI, and/or the C-RNTI. Additionally or alternatively, a Type2-PDCCH common search space may be defined for the DCI format(s) with CRC scrambled by the P-RNTI. Additionally or alternatively, a Type3-PDCCH common search space may be defined for the DCI format(s) with CRC scrambled by the C-RNTI, the CS-RNTI, and/or the first RNTI. Additionally or alternatively, the gNB 160 may transmit, in the CSS, DCI format(s) intended for a plurality of the UEs 102 and/or DCI format(s) intended for a specific UE 102.

The USS may be used for transmission of DCI to a specific UE 102. That is, the USS is defined by a resource dedicated to a certain UE 102. The USS may be defined independently for each UE 102. For example, the USS may be composed of CCEs having numbers that are determined based on a Radio Network Temporary Identifier (RNTI) (e.g., the C-RNTI, the CS-RNTI, the SP-CSI-RNTI, and/or the first RNTI), a slot number in a radio frame, an aggregation level, and/or the like. For example, each of the USSs corresponding to each of the RNTI(s) described below may be defined. For instance, the USS may be defined for the DCI format(s) with CRC scrambled by the C-RNTI, the CS-RNTI, the SP-CSI-RNTI, and/or the first RNTI. Additionally or alternatively, the gNB 160 may transmit, in the USS, DCI format(s) intended for a specific UE 102.

Here, the gNB 160 may transmit, by using the RRC message, first information used for configuring (e.g., determining) one or more CORESETs (e.g., an identity of the CORESET). Additionally or alternatively, for each of the one or more CORESETs, the search space sets (e.g., the sets of the CSS(s) and/or the USS) may be mapped. For example, each search space (e.g., each search space set) is associated with one CORESET. Here, the first information may be configured per serving cell. For instance, the first information may be configured for each of the primary cell(s) and the one or more secondary cell(s). Additionally or alternatively, the first information may be configured per DL BWP. For example, the first information may be configured for each of the DL BWPs in the serving cell.

Additionally or alternatively, the gNB 160 may transmit, by using the RRC message, second information used for configuring the search space set (e.g., the search space). Here, the search space set may include one or more search space. For example, one or more parameters may be configured for each search space set. For example, the second information may include information used for configuring an identity of the search space set. Additionally or alternatively, the second information may include information used for configuring an identity of the CORESET associated with the search space set. Additionally or alternatively, the second information may include information used for indicating a PDCCH monitoring periodicity and/or a PDCCH monitoring offset where the UE 102 monitors the PDCCH in the search space set. Additionally or alternatively, the second information may include information used for indicating a PDCCH monitoring pattern within a slot. For example, the information used for indicating the PDCCH monitoring pattern may be used for indicating first symbol(s) of the CORESET(s) within a slot for the PDCCH monitoring. For instance, the UE 102 may determine a PDCCH monitoring occasion(s) based on the PDCCH monitoring periodicity, the PDCCH monitoring offset, and/or the PDCCH monitoring pattern within a slot.

Additionally or alternatively, the second information may include information used for indicating a number of PDCCH candidates (e.g., a maximum number of PDCCH candidates) per CCE aggregation level. For example, 1, 2, 4, 8, 16, 32, and 64 may be defined for the CCE aggregation level(s) for the PDCCH monitoring. Additionally or alternatively, the number of PDCCH candidates (e.g., a maximum number of PDCCH candidates) may be defined per CCE aggregation level. For example, the CCE aggregation level(s) and the number of PDCCH candidates (e.g., a maximum number of PDCCH candidates) per CCE aggregation level for the CSS may be defined. Additionally or alternatively, the CCE aggregation level(s) and the number of PDCCH candidates (e.g., a maximum number of PDCCH candidates) per CCE aggregation level for the USS may be defined.

Additionally or alternatively, the second information may include information used for indicating a type of the search space set (e.g., information used for indicating that the search space set is corresponding to the CSS and/or the USS, information used for indicating that the search space set is either the CSS or the USS). Additionally or alternatively, the second information may include information used for indicating one or more DCI format(s) which accordingly the UE 102 monitors the PDCCH (e.g., the PDCCH candidates) in the search space set. For example, the gNB 160 may transmit, by using the RRC message, the second information used for indicating the one or more DCI format(s) to monitor the PDCCH (e.g., the PDCCH candidates). For example, if the search space set is the CSS (e.g., if the search space set is configured as the CSS), the DCI format 0_0 and the DCI format 1_0 may be configured to monitor the PDCCH (e.g., the PDCCH candidates). Additionally or alternatively, if the search space set is the CSS, the DCI format A and the DCI format B may be configured to monitor the PDCCH (e.g., the PDCCH candidates). Additionally or alternatively, if the search space set is the CSS, either of the DCI format 0_0 and the DCI format 1_0, or the DCI format A and the DCI format B may be configured to monitor the PDCCH (e.g., the PDCCH candidates). For example, if the search space set is the CSS, any combination of the DCI format 0_0, the DCI format 1_0, the DCI format A and/or the DCI format B may be configured to monitor the PDCCH (e.g., the PDCCH candidates). Here, the DCI format(s) for monitoring the PDCCH (e.g., the PDCCH candidates) in the CSS may be scrambled by the C-RNTI, the CS-RNTI, the SP-CSI-RNTI, the first RNTI, the RA-RNTI, the Temporary C-RNTI, the P-RNTI, and/or the SI-RNTI.

Additionally or alternatively, for example, if the search space set is the USS (e.g., if the search space set is configured as the USS), the DCI format 0_0 and the DCI format 1_0 may be configured to monitor the PDCCH (e.g., the PDCCH candidates). Additionally or alternatively, if the search space set is the USS, the DCI format 0_1 and the DCI format 1_1 may be configured to monitor the PDCCH (e.g., the PDCCH candidates). For example, if the search space set is the USS, either of the DCI format 0_0 and the DCI format 1_0, or the DCI format 0_1 and the DCI format 1_1 may be configured to monitor the PDCCH (e.g., the PDCCH candidates). Additionally or alternatively, if the search space set is the USS, the DCI format A and the DCI format B may be configured to monitor the PDCCH (e.g., the PDCCH candidates). For example, if the search space set is the USS, either of the DCI format 0_0 and the DCI format 1_0, or the DCI format A and the DCI format B may be configured to monitor the PDCCH (e.g., the PDCCH candidates). Additionally or alternatively, if the search space set is the USS, either of the DCI format 0_1 and the DCI format 1_1, or the DCI format A and the DCI format B may be configured to monitor the PDCCH (e.g., the PDCCH candidates). For example, if the search space set is the USS, any combination of the DCI format 0_0, the DCI format 1_0, the DCI format 0_1, the DCI format 1_1, the DCI format A, and/or the DCI format B may be configured to monitor the PDCCH (e.g., the PDCCH candidates). Here, the DCI format(s) for monitoring the PDCCH (e.g., the PDCCH candidates) in the USS may be scrambled by the C-RNTI, the CS-RNTI, and/or the first RNTI.

Additionally or alternatively, the second information may include information used for indicating one or more RNTI(s) which accordingly the UE 102 monitors the PDCCH (e.g., the PDCCH candidates) in the search space set. For example, the gNB 160 may transmit, by using the RRC message, the second information used for indicating the one or more RNTI(s) to monitor the PDCCH (e.g., the PDCCH candidates). For instance, if the search space set is the CSS, any combination(s) of the C-RNTI, the CS-RNTI, the first RNTI, the SP-CSI-RNTI, the RA-RNTI, the Temporary C-RNTI, the P-RNTI, and/or the SI-RNTI may be configured to monitor the PDCCH (e.g., the PDCCH candidates). For example, if the search space set is the CSS, either of the C-RNTI and the first RNTI, or the RA-RNTI and the Temporary C-RNTI and the P-RNTI and the SI-RNTI may be configured to monitor the PDCCH (e.g., the PDCCH candidates).

Here, the C-RNTI, the CS-RNTI, the SP-CSI-RNTI, the first RNTI, the RA-RNTI, the P-RNTI, and/or the SI-RNTI may be used for scrambling of CRC attached to the DCI format 0_1. Additionally or alternatively, the C-RNTI, the CS-RNTI, the SPCSI-RNTI, the first RNTI, the RA-RNTI, the P-RNTI, and/or the SI-RNTI may be used for scrambling of CRC attached to the DCI format 1_1. Additionally or alternatively, the C-RNTI, the CS-RNTI, the SP-CSI-RNTI, the first RNTI, the RA-RNTI, the P-RNTI, and/or the SI-RNTI may be used for scrambling of CRC attached to the DCI format A. Additionally or alternatively, the C-RNTI, the CS-RNTI, the SPCSI-RNTI, the first RNTI, and/or the Temporary C-RNTI may be used for scrambling of CRC attached to the DCI format 0_0. Additionally or alternatively, the C-RNTI, the CS-RNTI, the SP-CSI-RNTI, the first RNTI and/or the Temporary C-RNTI may be used for scrambling of CRC attached to the DCI format 0_1. Additionally or alternatively, the C-RNTI, the CS-RNTI, the SP-CSI-RNTI, the first RNTI, and/or the Temporary C-RNTI may be used for scrambling of CRC attached to the DCI format B.

Here, the second information may be configured per serving cell. For example, the second information may be configured for each of the primary cell(s) and the one or more secondary cell(s). Additionally or alternatively, the second information may be configured per DL BWP. For example, the second information may be configured for each of DL BWPs in the serving cell. Additionally or alternatively, the third information may be configured per serving cell. For example, the third information may be configured for each of the primary cell(s) and the one or more secondary cell(s). Additionally or alternatively, the third information may be configured per DL BWP. For example, the third information may be configured for each of DL BWPs in the serving cell.

Here, for example, for the serving cell(s), the gNB 160 may configure, by using the RRC message, a set of four DL BWPs (e.g., at most four DL BWPs, a DL BWP set) (e.g., for receptions by the UE 102). Additionally or alternatively, the gNB 160 may configure, by using the RRC message, the initial active DL BWP(s), the default DL BWP(s), and/or the active DL BWP(s). Additionally or alternatively, the gNB 160 may indicate, by using the DCI format(s) for the downlink, the active DL BWP(s). For example, for each DL BWP in the set of DL BWPs, the gNB 160 may configure, by using the RRC message, the subcarrier spacing, the cyclic prefix, a number of contiguous PRBs (e.g., a bandwidth of PRBs), and/or an index (e.g., the index of the DL BWP(s), the DL BWP ID) in the set of DL BWPs.

Additionally or alternatively, for the serving cell(s), the gNB 160 may configure, by using the RRC message, a set of four UL BWP(s) (e.g., at most four UL BWPs, a UL BWP set) (e.g., for transmissions by the UE 102). Additionally or alternatively, the gNB 160 may configure, by using the RRC message, the initial active UL BWP(s), the default UL BWP(s), and/or the active UL BWP(s). Additionally or alternatively, the gNB 160 may indicate, by using the DCI format(s) for the uplink, the active UL BWP(s). Additionally or alternatively, for each UL BWP in the set of UL BWPs, the gNB 160 may configure, by using the RRC message, the subcarrier spacing, the cyclic prefix, a number of contiguous PRBs (e.g., a bandwidth of PRBs), an index (e.g., the index of the UL BWP(s), the UL BWP ID) in the set of UL BWPs.

Additionally or alternatively, the UE 102 may perform, based on the configuration(s) for the DL BWP(s), reception(s) on the PDCCH in the DL BWP(s) and/or reception(s) on the PDSCH in the DL BWP(s). For example, the UE 102 may perform, based on the configured subcarrier spacing and cyclic prefix (e.g., the cyclic prefix length) for the DL BWP(s), the reception(s) on the PDCCH in the DL BWP(s) and/or the reception(s) on the PDSCH in the DL BWP(s). Additionally or alternatively, the UE 102 may perform, based on the configuration(s) for the UL BWP(s), transmission(s) on the PUCCH in the UL BWP(s) and/or transmission(s) on the PUSCH in the UL BWP(s). For example, the UE 102 may perform, based on the configured subcarrier spacing and cyclic prefix (e.g., the cyclic prefix length) for the UL BWP(s), the transmission(s) on the PUCCH in the UL BWP(s) and/or the transmission(s) on the PUSCH in the UL BWP(s).

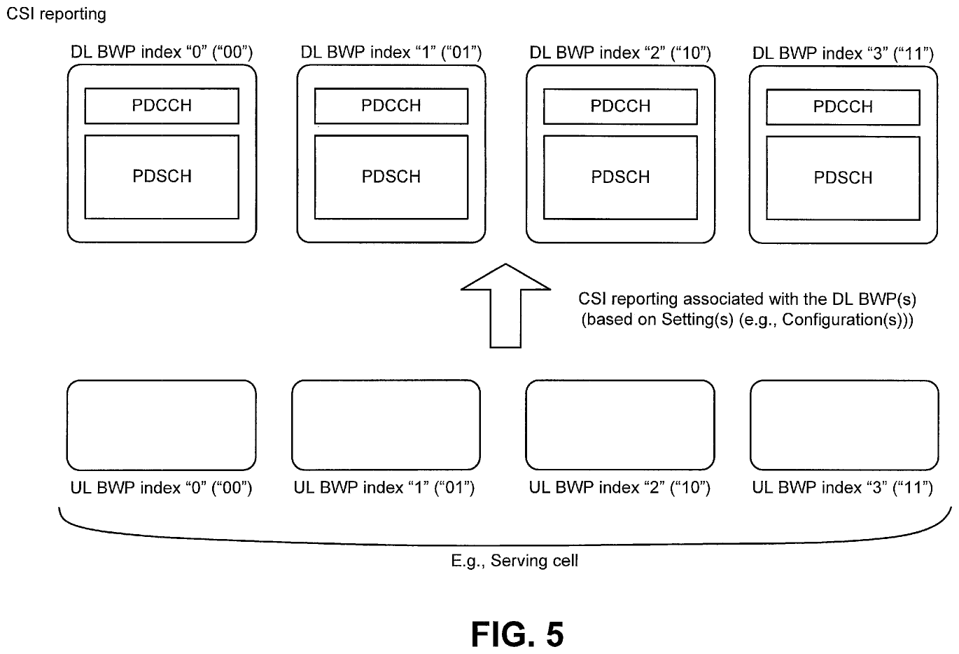

FIG. 5 illustrates an example of CSI reporting. A UE procedure for reporting channel state information (CSI) is described herein. Regarding a channel state information framework, the time and frequency resources that can be used by the UE 102 to report CSI may be controlled by the gNB 160. CSI may consist of channel quality indicator (CQI), preceding matrix indicator (PMI), CSI-RS resource indicator (CRI), SS/PBCH Block Resource indicator (SSBRI), layer indicator (LI), rank indicator (RI) and/or L1-RSRP.

For CQI, PMI, CRI, SSBRI, LI, RI, L1-RSRP, a UE 102 may be configured by higher layers with N≥1 CSI-ReportConfig Reporting Settings, M≥1 CSI-ResourceConfig Resource Settings, and one or two list(s) of trigger states (given by the higher layer parameters aperiodicTriggerStateList and semiPersistentOnPUSCH-TriggerStateList). Each trigger state in aperiodicTriggerStateList may contain a list of associated CSI-ReportConfigs indicating the Resource Set IDs for channel and optionally for interference. Each trigger state in semiPersistentOnPUSCH-TriggerStateList contains one associated CSI-ReportConfig.

Each Reporting Setting CSI-ReportConfig may be associated with a single downlink BWP (indicated by higher layer parameter bwp-Id) given in the associated CSI-ResourceConfig for channel measurement. The time domain behavior of the CSI-ReportConfig may be indicated by the higher layer parameter reportConfigType and may be set to ‘aperiodic’, ‘semiPersistentOnPUCCH’, ‘semiPersistentOnPUSCH’, or ‘periodic’. For periodic and semiPersistentOnPUCCH/semiPersistentOnPUSCH CSI reporting, the configured periodicity and slot offset may apply in the numerology of the UL BWP in which the CSI report is configured to be transmitted on.

The reporting configuration for CSI may be aperiodic (using PUSCH), periodic (using PUCCH) or semi-persistent (using PUCCH, and DCI activated PUSCH). The CSI-RS resources may be periodic, semi-persistent, or aperiodic. Table 1 shows the supported combinations of CSI reporting configurations and CSI-RS resource configurations and how the CSI reporting may be triggered for each CSI-RS resource configuration. Periodic CSI-RS may be configured by higher layers.

TABLE 1

| CSI-RS | Periodic CSI | Semi-Persistent | Aperiodic CSI |
|---|---|---|---|
| Configuration | Reporting | CSI Reporting | Reporting |
| Periodic | No dynamic | For reporting on | Triggered by DCI; |
| CSI-RS | triggering/ | PUCCH, the UE | additionally, |
| | activation | receives an | activation |
| | | activation | command. |
| | | command; for | |
| | | reporting on | |
| | | PUSCH, the UE | |
| | | receives triggering | |
| | | on DCI | |
| Semi-Persistent | Not | For reporting on | Triggered by DCI; |
| CSI-RS | Supported | PUCCH, the UE | additionally, |
| | | receives an | activation |
| | | activation | command. |
| | | command; for | |
| | | reporting on | |
| | | PUSCH, the UE | |
| | | receives triggering | |
| | | on DCI | |
| Aperiodic | Not | Not Supported | Triggered by DCI; |
| CSI-RS | Supported | | additionally, |
| | | | activation |
| | | | command. |

For a periodic or semi-persistent CSI report on PUCCH, the periodicity (measured in slots) may be configured by the higher layer parameter reportSlotConfig. For a semi-persistent or aperiodic CSI report on PUSCH, the allowed slot offsets may be configured by the higher layer parameter reportSlotOffsetList. The offset may be selected in the activating/triggering DCI.

With respect to resource setting configuration, for aperiodic CSI, each trigger state configured using the higher layer parameter CSI-AperiodicTriggerState may be associated with one or multiple CSI-ReportConfig where each CSI-ReportConfig is linked to periodic, or semi-persistent, or aperiodic resource setting(s). For semi-persistent or periodic CSI, each CSI-ReportConfig may be linked to periodic or semi-persistent resource setting(s).

Triggering and activation of CSI reports and CSI-RS are described herein. With regard to aperiodic CSI reporting and aperiodic CSI-RS, for CSI-RS resource sets associated with resource settings configured with the higher layer parameter resourceType set to ‘aperiodic’, ‘periodic’, or semi-persistent’, trigger states for reporting setting(s) (configured with the higher layer parameter reportConfigType set to ‘aperiodic’) and/or resource setting for channel and/or interference measurement on one or more component carriers may be configured using the higher layer parameter CSI-AperiodicTriggerStateList. For aperiodic CSI report triggering, a single set of CSI triggering states may be higher layer configured, where the CSI triggering states can be associated with any candidate DL BWP. A trigger state may be initiated using the CSI request field in DCI.

With regard to semi-persistent CSI and semi-persistent CSI-RS, for semi-persistent reporting on PUSCH, a set of semi-persistent reporting settings are higher layer configured by CSI-SemiPersistentOnPUSCH-TriggerStateList, the CSI request field in DCI scrambled with the SP-CSI-RNTI may activate one of the semi-persistent CSI reports and the PUCCH resource used for transmitting the CSI report may be configured by reportConfigType. Semi-persistent reporting on PUCCH may be activated by an activation command, which selects one of the semi-persistent reporting settings for use by the UE 102 on the PUCCH.

CSI reporting using PUSCH is also described herein. A UE 102 may perform aperiodic CSI reporting using PUSCH on serving cells upon successful decoding of the DCI format(s). An aperiodic CSI report carried on the PUSCH may support wideband, and sub-band frequency granularities.

A UE may perform semi-persistent CSI reporting on the PUSCH upon successful decoding of the DCI format(s) which activates a semi-persistent CSI trigger state. The DCI format(s) contains the CSI request field which indicates the semi-persistent CSI trigger state to activate or deactivate. The PUSCH resources and MCS may be allocated semi-persistently by the DCI format(s).

CSI reporting using PUCCH is also described herein. A UE 102 may be semi-statically configured by higher layers to perform periodic CSI reporting on the PUCCH. A UE 102 may be configured by higher layers for multiple periodic CSI reports corresponding to one or more higher layer configured CSI reporting setting indications, where the associated CSI measurement links and CSI resource settings are higher layer configured.

The channel quality indicator (CQI) is also described herein. The CQI indices and their interpretations may be given in Table 2 (also referred to as the first CQI table) or Table 4 (also referred to as the third CQI table) for reporting CQI based on QPSK, 16QAM and 64QAM. The CQI indices and their interpretations are given in the Table 3 (also referred to as the second CQI table) for reporting CQI based on QPSK, 16QAM, 64QAM and 256QAM.

TABLE 2

| CQI | | | |
|---|---|---|---|
| Index | Modulation | Code Rate × 1024 | Efficiency |
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16 QAM | 378 | 1.4766 |
| 8 | 16 QAM | 490 | 1.9141 |
| 9 | 16 QAM | 616 | 2.4063 |
| 10 | 64 QAM | 466 | 2.7305 |
| 11 | 64 QAM | 567 | 3.3223 |
| 12 | 64 QAM | 666 | 3.9023 |
| 13 | 64 QAM | 772 | 4.5234 |
| 14 | 64 QAM | 873 | 5.1152 |
| 15 | 64 QAM | 948 | 5.5547 |

TABLE 3

| CQI | | | |
|---|---|---|---|
| Index | Modulation | Code Rate × 1024 | Efficiency |
| 0 | out of range | | |
| 1 | QPSK | 78 | 0.1523 |
| 2 | QPSK | 193 | 0.3770 |
| 3 | QPSK | 449 | 0.8770 |
| 4 | 16 QAM | 378 | 1.4766 |
| 5 | 16 QAM | 490 | 1.9141 |
| 6 | 16 QAM | 616 | 2.4063 |
| 7 | 64 QAM | 466 | 2.7305 |
| 8 | 64 QAM | 567 | 3.3223 |
| 9 | 64 QAM | 666 | 3.9023 |
| 10 | 64 QAM | 772 | 4.5234 |
| 11 | 64 QAM | 873 | 5.1152 |
| 12 | 256 QAM | 711 | 5.5547 |
| 13 | 256 QAM | 797 | 6.2266 |
| 14 | 256 QAM | 885 | 6.9141 |
| 15 | 256 QAM | 948 | 7.4063 |

TABLE 4

| CQI | | | |
|---|---|---|---|
| Index | Modulation | Code Rate × 1024 | Efficiency |
| 0 | out of range | | |
| 1 | QPSK | 30 | 0.0586 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16 QAM | 378 | 1.4766 |
| 10 | 16 QAM | 490 | 1.9141 |
| 11 | 16 QAM | 616 | 2.4063 |
| 12 | 64 QAM | 466 | 2.7305 |
| 13 | 64 QAM | 567 | 3.3223 |
| 14 | 64 QAM | 666 | 3.9023 |
| 15 | 64 QAM | 772 | 4.5234 |

The UE 102 may derive for each CQI value reported in uplink slot n the highest CQI index that satisfies the following condition. A single PDSCH transport block with a combination of modulation scheme, target code rate and transport block size corresponding to the CQI index, and occupying a group of downlink physical resource blocks termed the CSI reference resource, may be received with a transport block error probability not exceeding 0.1, if Table 2 is used (e.g., selected), or Table 3 is used (e.g., selected), or 0.00001, if Table 4 is used (e.g., selected).

The UE 102 may derive the channel measurements for computing CSI value reported in uplink slot n based on only the NZP CSI-RS, no later than the CSI reference resource, associated with the CSI resource setting.

Additionally or alternatively, the UE 102 may derive the channel measurements for computing CSI reported in uplink slot n based on only the most recent, no later than the CSI reference resource, occasion of NZP CSI-RS associated with the CSI resource setting.

Additionally or alternatively, the UE 102 may derive the interference measurements for computing CSI value reported in uplink slot n based on only the CSI-IM and/or NZP CSI-RS for interference measurement no later than the CSI reference resource associated with the CSI resource setting.

Additionally or alternatively, the UE 102 may derive the interference measurements for computing the CSI value reported in uplink slot n based on the most recent, no later than the CSI reference resource, occasion of CSI-IM and/or NZP CSI-RS for interference measurement associated with the CSI resource setting.

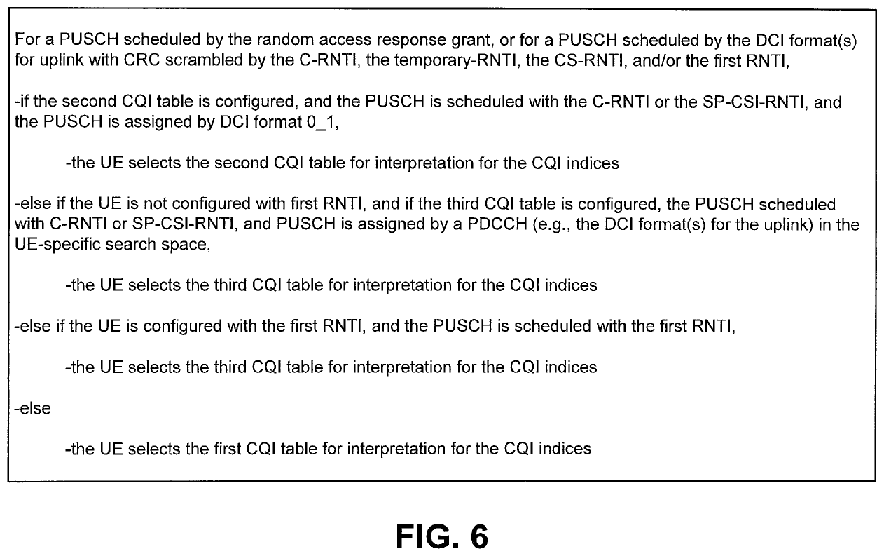

FIG. 6 illustrates an example of selecting the CQI table(s). As described above, the UE 102 may perform the periodic CSI reporting on the PUCCH. Also, the UE 102 may perform the semi-persistent CSI reporting (i.e., the SP-CSI reporting) on the PUCCH. Also, the UE 102 may perform the SP-CSI reporting on the PUSCH. Also, the UE 102 may perform the aperiodic CSI reporting on the PUSCH. Here, the gNB 160 may transmit, by using the RRC message, fourth information (e.g., a parameter) used for configuring the CQI table(s) (e.g., the first CQI table, the second CQI table, and/or the third CQI table). For example, the fourth information may be included in CSI-ReportConfig.

Here, the fourth information may be configured per serving cell. For example, the fourth information may be configured for each of the primary cell(s) and the one or more secondary cell(s). Additionally or alternatively, the fourth information may be configured per DL BWP. For example, the second information may be configured for each of DL BWPs in the serving cell. Also, the fourth information may be separately configured for each of the CSI reporting types (e.g., the periodic CSI reporting (e.g., on the PUCCH), the semi-persistent CSI reporting (e.g., on the PUSCH and/or the PUCCH), and/or the aperiodic CSI reporting (e.g., on the PUSCH)). Also, the fourth information may be commonly configured for each of the CSI reporting types.

The UE 102 may select (e.g., determine, use) the CQI table based on the fourth information. Namely, in a case that the first CQI table is configured, the UE 102 may select the first CQI table (e.g., for the interpretation for the CQI indices). Also, in a case that the second CQI table is configured, the UE 102 may select the second CQI table (e.g., for the interpretation for the CQI indices) Namely, in a case that the third CQI table is configured, the UE 102 may select the third CQI table (e.g., for the interpretation for the CQI indices). For example, in a case that the periodic CSI reporting on the PUCCH is performed (i.e., for the periodic CSI reporting on the PUCCH), the UE 102 may select the CQI table based on the fourth information. Also, in a case that the SP-CSI reporting on the PUCCH is performed (i.e., for the SP-CSI reporting on the PUCCH), the UE 102 may select the CQI table based on the fourth information. Also, in a case that the SP-CSI reporting on the PUSCH is performed (i.e., for the SP-CSI reporting on the PUSCH), the UE 102 may select the CQI table based on the fourth information. Also, in a case that the aperiodic CSI reporting is performed (i.e., for the aperiodic CSI reporting), the UE 102 may select the CQI table based on the fourth information.

Here, in a case that the CSI reporting on the PUCCH (e.g., the periodic CSI reporting on the PUCCH, and/or the SP-CSI reporting on the PUCCH) is performed, the UE 102 may use the fourth information (e.g., only the fourth information) to select the CQI table. Namely, for the CSI reporting on the PUCCH, the UE 102 may always follow the fourth information (e.g., only the fourth information) to select the CQI table.

And, in a case that the CSI reporting on the PUSCH (e.g., the SP-CSI reporting on the PUSCH, and/or the aperiodic CSI reporting on the PUSCH) is performed, the UE 102 may use a condition(s) to select the CQI table. Namely, for the CSI reporting on the PUSCH, the UE 102 may follow the condition(s) to select the CQI table. Here, for example, the condition(s) may include the CQI table(s) configured by using the fourth information. Additionally or alternatively, the condition(s) may include RNTI(s) (e.g., the C-RNTI, the SP-CSI-RNTI, the first RNTI, the RA-RNTI, and/or the Temporary C-RNTI) used for scheduling of the PUSCH (e.g., used for scheduling of the CSI reporting on the PUSCH, activating of the CSI reporting on the PUSCH). Additionally or alternatively, the conditions(s) may include information (e.g., the DCI format(s) (e.g., the DCI format 0_0, the DCI format 0_1, and/or the DCI format B), and/or the random access response grant) used for scheduling of the PUSCH (e.g., used for scheduling of the CSI reporting on the PUSCH, activating of the CSI reporting on the PUSCH). Additionally or alternatively, the condition(s) may include the search space(s) (e.g., the search space set(s), the type of search space(s) (e.g., the search space set(s))) where the PDCCH (e.g., the DCI format(s) for the uplink) is detected. Here, the PDCCH (e.g., the DCI format(s) for the uplink) may be used for scheduling of the PUSCH (e.g., used for scheduling of the CSI reporting on the PUSCH, activating of the CSI reporting on the PUSCH).

For example, as described in FIG. 6, if the second CQI table is configured, and the PUSCH is scheduled with the C-RNTI (e.g., by using the DCI format(s) with CRC scrambled by the C-RNTI) or the SP-CSI-RNTI (e.g., by using the DCI format(s) with CRC scrambled by the SP-CSI-RNTI), and the PUSCH is assigned by the DCI format 0_1, the UE 102 may select the second CQI table. Also, if the first RNTI is not configured, and if the third CQI table is configured, and the PUSCH is scheduled with the C-RNTI or the SP-CSI-RNTI, and the PUSCH is assigned by the PDCCH (e.g., the DCI format(s)) in the USS, the UE 102 may select the third CQI table. Also, if the first RNTI is configured, and if the PUSCH is scheduled with the first RNTI (e.g., by using the DCI format(s) with CRC scrambled by the first RNTI), the UE 102 may select the third CQI table. Otherwise, the UE 102 may select the first CQI table.

Namely, for the CSI reporting on the PUSCH (e.g., the SP-CSI reporting on the PUSCH and/or the aperiodic CSI reporting), based on that the PUSCH is scheduled by using DCI format(s) (e.g., the DCI format 0_0, the DCI format 0_1, and/or the DCI format B) with CRC scrambled by the C-RNTI or the SP-CSI-RNTI, the UE 102 may select the CQI table(s) (e.g., the first CQI table, the second CQI table, and/or the third CQI table). For example, in a case that the first CQI table is configured, based on that the PUSCH is scheduled by using DCI format(s) with CRC scrambled by the C-RNTI or the SP-CSI-RNTI, the UE 102 may select the first CQI table. Also, in a case that the second CQI table is configured, based on that the PUSCH is scheduled by using DCI format(s) with CRC scrambled by the C-RNTI or the SP-CSI-RNTI, the UE 102 may select the second CQI table. Also, in a case that the third CQI table is configured, based on that the PUSCH is scheduled by using DCI format(s) with CRC scrambled by the C-RNTI or the SP-CSI-RNTI, the UE 102 may select the third CQI table. Also, for the CSI reporting on the PUSCH (e.g., the SP-CSI reporting on the PUSCH and/or the aperiodic CSI reporting), based on that the PUSCH is scheduled by using DCI format(s) (e.g., the DCI format 0_0, the DCI format 0_1, and/or the DCI format B) with CRC scrambled by the first RNTI, the UE 102 may select the third CQI table. For example, even if the first CQI table and/or the second CQI table is configured, based on that the PUSCH is scheduled by using DCI format(s) with CRC scrambled by the first RNTI, the UE 102 may select the third CQI table. Here, based on that the PUSCH is scheduled by using DCI format(s) with CRC scrambled by the first RNTI, the UE may select the first CQI table and/or the second CQI table (e.g., based on the fourth information).

Also, for the CSI reporting on the PUSCH (e.g., the SP-CSI reporting on the PUSCH and/or the aperiodic CSI reporting), based on that the PUSCH is scheduled by using the random access response grant, the UE 102 may select the first CQI table. For example, even if the second CQI table and/or the third CQI table is configured, based on that the PUSCH is scheduled by using the random access response grant, the UE 102 may select the first CQI table. Here, based on that the PUSCH is scheduled by using the random access response grant, the UE may select the second CQI table and/or the third CQI table (e.g., based on the fourth information). As described above, the random access response grant may be included in the PDSCH scheduled by using the DCI format(s) (e.g., the DCI format 1_0, and/or the DCI format 1_1) with CRC scrambled by the RA-RNTI. Namely, for the CSI reporting on the PUSCH (e.g., the SP-CSI reporting on the PUSCH and/or the aperiodic CSI reporting), based on that the PUSCH is associated with the RA-RNTI (e.g., the PUSCH transmission is a part of the random access procedure), the UE 102 may select the first CQI table. For example, even if the second CQI table and/or the third CQI table is configured, based on that the PUSCH is associated with the RA-RNTI (e.g., the PUSCH transmission is a part of the random access procedure), the UE 102 may select the first CQI table. Here, based on that the PUSCH is associated with the RA-RNTI (e.g., the PUSCH transmission is a part of the random access procedure), the UE may select the second CQI table and/or the third CQI table (e.g., based on the fourth information).

Also, for the CSI reporting on the PUSCH (e.g., the SP-CSI reporting on the PUSCH and/or the aperiodic CSI reporting), based on that the PUSCH is scheduled by using the DCI format(s) (e.g., the DCI format 0_0 and/or the DCI format 0_1) with CRC scrambled by the Temporary C-RNTI, the UE 102 may select the first CQI table. For example, even if the second CQI table and/or the third CQI table is configured, based on that the PUSCH is scheduled by using the DCI format(s) with CRC scrambled by the Temporary C-RNTI, the UE 102 may select the first CQI table. Here, based on that the PUSCH is scheduled by using the DCI format with CRC scrambled by the Temporary C-RNTI, the UE may select the second CQI table and/or the third CQI table (e.g., based on the fourth information).

Additionally or alternatively, for the CSI reporting on the PUSCH (e.g., the SP-CSI reporting on the PUSCH and/or the aperiodic CSI reporting), based on that the PUSCH is scheduled by using DCI format 0_1 (e.g., in the CSS and/or the USS), the, the UE 102 may select the first CQI table. Additionally or alternatively, if the first CQI table is configured, and based on that the PUSCH is scheduled by using DCI format 0_1 (e.g., in the CSS and/or the USS), the, the UE 102 may select the first CQI table. Additionally or alternatively, if the second CQI table is configured, and based on that the PUSCH is scheduled by using DCI format 0_1 (e.g., in the CSS and/or the USS), the, the UE 102 may select the second CQI table. Additionally or alternatively, if the third CQI table is configured, and based on that the PUSCH is scheduled by using DCI format 0_1 (e.g., in the CSS and/or the USS), the, the UE 102 may select the third CQI table.

Additionally or alternatively, for the CSI reporting on the PUSCH (e.g., the SP-CSI reporting on the PUSCH and/or the aperiodic CSI reporting), based on that the PUSCH is scheduled by using DCI format 0_1 (e.g., in the CSS and/or the USS), the UE 102 may select the second CQI table and/or the third CQI table (e.g., based on the fourth information). For example, if the first RNTI is not configured, based on that the PUSCH is scheduled by using DCI format 0_1 (e.g., in the CSS and/or the USS) with CRC scrambled by the C-RNTI and/or the SP-CSI RNTI, the, the UE 102 may select the second CQI table and/or the third CQI table (e.g., based on the fourth information). Also, if the first RNTI is configured, based on that the PUSCH is scheduled by using DCI format 0_1 (e.g., in the CSS and/or the USS) with CRC scrambled by the first RNTI, the, the UE 102 may select the third CQI table.

Additionally or alternatively, for the CSI reporting on the PUSCH (e.g., the SP-CSI reporting on the PUSCH and/or the aperiodic CSI reporting), based on that the PUSCH is scheduled by using DCI format B (e.g., in the CSS and/or the USS), the UE 102 may select the third CQI table. For example, even if the first CQI table and/or the second CQI table is configured, based on that the PUSCH is scheduled by using the DCI format B (e.g., in the CSS and/or the USS), the UE 102 may select the third CQI table. Here, if the first RNTI is not configured, based on that the PUSCH is scheduled by using DCI format B (e.g., in the CSS and/or the USS) with CRC scrambled by the C-RNTI and/or the SP-CSI RNTI, the, the UE 102 may select the second CQI table and/or the third CQI table (e.g., based on the fourth information). Also, if the first RNTI is configured, based on that the PUSCH is scheduled by using DCI format B (e.g., in the CSS and/or the USS) with CRC scrambled by the first RNTI, the, the UE 102 may select the third CQI table.

Additionally or alternatively, for the CSI reporting on the PUSCH (e.g., the SP-CSI reporting on the PUSCH and/or the aperiodic CSI reporting), based on that the PUSCH is scheduled by using DCI format(s) (e.g., the DCI format 0_0, the DCI format 0_1, and/or the DCI format B) in the CSS, the UE 102 may select the first CQI table. For example, even if the second CQI table and/or the third CQI table is configured, based on that the PUSCH is scheduled by using the DCI format(s) in the CSS, the UE 102 may select the first CQI table. Additionally or alternatively, for the CSI reporting on the PUSCH (e.g., the SP-CSI reporting on the PUSCH and/or the aperiodic CSI reporting), based on that the PUSCH is scheduled by using DCI format(s) (e.g., the DCI format 0_0, the DCI format 0_1, and/or the DCI format B) in the USS, the UE 102 may select the first CQI table, the second CQI table, and/or the third CQI table (e.g., based on the fourth information and/or the first RNTI). For example, in a case that the first RNTI is not configured, based on that the PUSCH is scheduled by using the DCI format(s) in the USS (e.g., the DCI format(s) with CRC scrambled by the C-RNTI and/or the SP-CSI-RNTI), the UE 102 may select the first CQI table and/or the second CQI table (e.g., based on the fourth information). Also, in a case that the first RNTI is configured, based on that the PUSCH is scheduled by using the DCI format(s) in the USS (e.g., the DCI format(s) with CRC scrambled by the first RNTI), the UE 102 may select the third CQI table.

Additionally or alternatively, for the CSI reporting on the PUSCH (e.g., the SP-CSI reporting on the PUSCH and/or the aperiodic CSI reporting), the trigger state(s) (e.g., the trigger state(s) of the CSI request field) may be corresponding to (e.g., associated with, linked to) the CQI table(s). As described above, the CQI request (e.g., the CQI request field set to trigger the CSI report) may be used for requesting (e.g., triggering, activating) the CSI reporting on the PUSCH. Here, as one example, in a case where 2-bit CSI request field is described, however, the size of CSI request field may be any bit. For example, in a case that the size of the CSI request field is 2-bit, the CSI reporting on the PUSCH may be requested (e.g., triggered, activated) based on a value(s) (i.e., a value(s) of the CSI request field corresponding to the CSI reporting on the PUSCH). For example, in a case that the value(s) of the CSI request field is “00” (e.g., the CSI request field is set to a first value(s)), the CSI reporting on the PUSCH may not be requested. For example, in a case that the value(s) of the CSI request field is “01”, “10”, and/or “11” (e.g., the CSI request field is set to a second value(s), a third value(s), and/or the fourth value(s)), the CSI reporting on the PUSCH may be requested. Here, the gNB 160 may transmit, by using the RRC message, fifth information used for configuring a correspondence between the value(s) of the CSI request field and the CQI table(s).

Here, the fifth information may be configured per serving cell. For example, the fifth information may be configured for each of the primary cell(s) and the one or more secondary cell(s). Additionally or alternatively, the fifth information may be configured per DL BWP. For example, the fifth information may be configured for each of DL BWPs in the serving cell. Also, the fifth information may be separately configured for each of PUSCH CSI reporting types (e.g., the semi-persistent CSI reporting on the PUSCH, and/or the aperiodic CSI reporting). Also, the fifth information may be commonly configured for each of the PUSCH CSI reporting types.

For example, the gNB may configure that the value of the CSI request field “01” is corresponding to the second CQI table. Also, the gNB may configure that the value of the CSI request field “10” is corresponding to the first CQI table. Also, the gNB may configure that the value of the CSI request field “11” is corresponding to the third CQI table. And, the UE 102 perform, based on the fifth information and/or the value(s) of the CSI request field, the CSI reporting on the PUSCH. Namely, in a case that the CSI reporting on the PUSCH is requested (e.g., triggered, activated) by the value of the CSI request field “01”, the UE 102 select the second table (e.g., for the interpretation for the CQI indices). Also, in a case that the CSI reporting on the PUSCH is requested (e.g., triggered, activated) by the value of the CSI request field “10”, the UE 102 select the first table (e.g., for the interpretation for the CQI indices). Also, in a case that the CSI reporting on the PUSCH is requested (e.g., triggered, activated) by the value of the CSI request field “11”, the UE 102 select the third table (e.g., for the interpretation for the CQI indices). Here, the CSI reporting on the PUSCH may be requested (e.g., triggered, activated) by using the DCI format(s) with CRC scrambled by the C-RNTI, the SP-CSI-RNTI, and/or the first RNTI. Additionally or alternatively, the CSI reporting on the PUSCH may be requested (e.g., triggered, activated) by using only the DCI format(s) with CRC scrambled by the first RNTI. For example, the CSI reporting on the PUSCH may be requested (e.g., triggered, activated) by using only the DCI format 0_1 with CRC scrambled by the first RNTI.

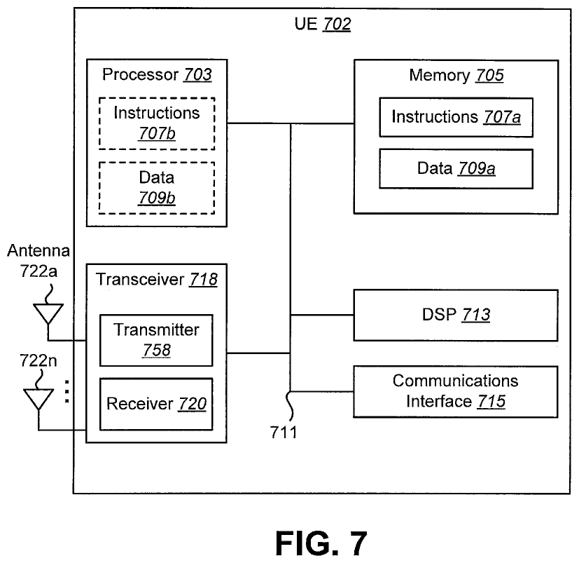

FIG. 7 illustrates various components that may be utilized in a UE 702. The UE 702 described in connection with FIG. 7 may be implemented in accordance with the UE 102 described in connection with FIG. 1. The UE 702 includes a processor 703 that controls operation of the UE 702. The processor 703 may also be referred to as a central processing unit (CPU). Memory 705, which may include read-only memory (ROM), random access memory (RAM), a combination of the two or any type of device that may store information, provides instructions 707a and data 709a to the processor 703. A portion of the memory 705 may also include non-volatile random access memory (NVRAM). Instructions 707b and data 709b may also reside in the processor 703. Instructions 707b and/or data 709b loaded into the processor 703 may also include instructions 707a and/or data 709a from memory 705 that were loaded for execution or processing by the processor 703. The instructions 707b may be executed by the processor 703 to implement the methods described herein.

The UE 702 may also include a housing that contains one or more transmitters 758 and one or more receivers 720 to allow transmission and reception of data. The transmitter(s) 758 and receiver(s) 720 may be combined into one or more transceivers 718. One or more antennas 722a-n are attached to the housing and electrically coupled to the transceiver 718.

The various components of the UE 702 are coupled together by a bus system 711, which may include a power bus, a control signal bus and a status signal bus, in addition to a data bus. However, for the sake of clarity, the various buses are illustrated in FIG. 7 as the bus system 711. The UE 702 may also include a digital signal processor (DSP) 713 for use in processing signals. The UE 702 may also include a communications interface 715 that provides user access to the functions of the UE 702. The UE 702 illustrated in FIG. 7 is a functional block diagram rather than a listing of specific components.

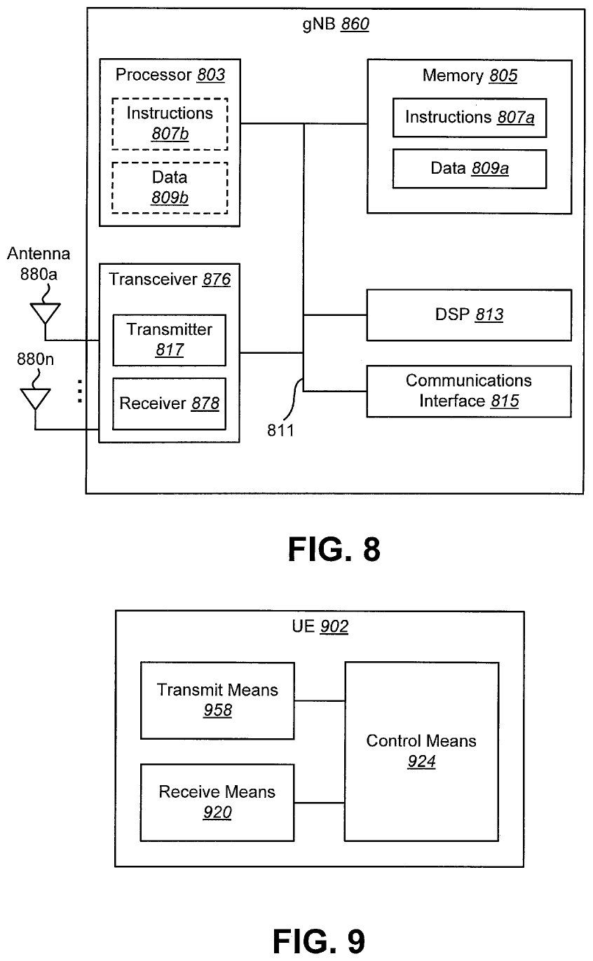

FIG. 8 illustrates various components that may be utilized in a gNB 860. The gNB 860 described in connection with FIG. 8 may be implemented in accordance with the gNB 160 described in connection with FIG. 1. The gNB 860 includes a processor 803 that controls operation of the gNB 860. The processor 803 may also be referred to as a central processing unit (CPU). Memory 805, which may include read-only memory (ROM), random access memory (RAM), a combination of the two or any type of device that may store information, provides instructions 807a and data 809a to the processor 803. A portion of the memory 805 may also include non-volatile random access memory (NVRAM). Instructions 807b and data 809b may also reside in the processor 803. Instructions 807b and/or data 809b loaded into the processor 803 may also include instructions 807a and/or data 809a from memory 805 that were loaded for execution or processing by the processor 803. The instructions 807b may be executed by the processor 803 to implement the methods described herein.

The gNB 860 may also include a housing that contains one or more transmitters 817 and one or more receivers 878 to allow transmission and reception of data. The transmitter(s) 817 and receiver(s) 878 may be combined into one or more transceivers 876. One or more antennas 880a-n are attached to the housing and electrically coupled to the transceiver 876.

The various components of the gNB 860 are coupled together by a bus system 811, which may include a power bus, a control signal bus and a status signal bus, in addition to a data bus. However, for the sake of clarity, the various buses are illustrated in FIG. 8 as the bus system 811. The gNB 860 may also include a digital signal processor (DSP) 813 for use in processing signals. The gNB 860 may also include a communications interface 815 that provides user access to the functions of the gNB 860. The gNB 860 illustrated in FIG. 8 is a functional block diagram rather than a listing of specific components.

FIG. 9 is a block diagram illustrating one implementation of a UE 902 in which one or more of the systems and/or methods described herein may be implemented. The UE 902 includes transmit means 958, receive means 920 and control means 924. The transmit means 958, receive means 920 and control means 924 may be configured to perform one or more of the functions described in connection with FIG. 1 above. FIG. 7 above illustrates one example of a concrete apparatus structure of FIG. 9. Other various structures may be implemented to realize one or more of the functions of FIG. 1. For example, a DSP may be realized by software.

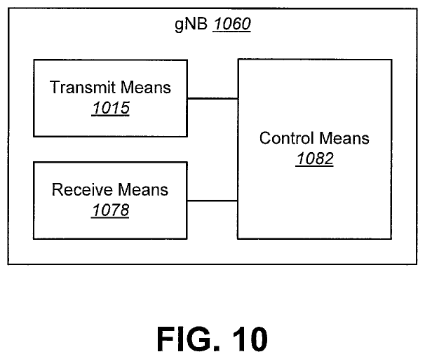

FIG. 10 is a block diagram illustrating one implementation of a gNB 1060 in which one or more of the systems and/or methods described herein may be implemented. The gNB 1060 includes transmit means 1017, receive means 1078 and control means 1082. The transmit means 1017, receive means 1078 and control means 1082 may be configured to perform one or more of the functions described in connection with FIG. 1 above. FIG. 8 above illustrates one example of a concrete apparatus structure of FIG. 10. Other various structures may be implemented to realize one or more of the functions of FIG. 1. For example, a DSP may be realized by software.

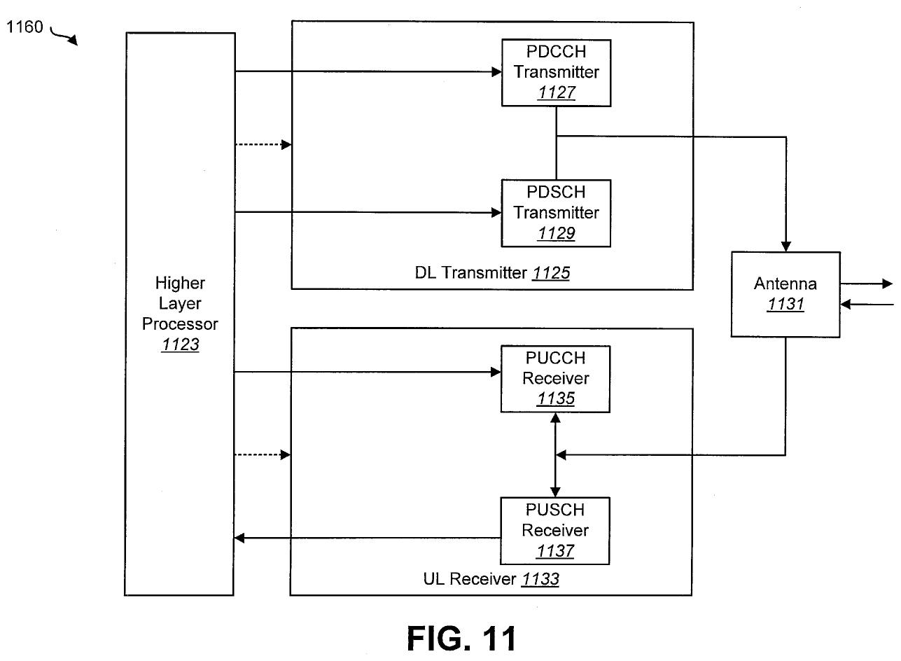

FIG. 11 is a block diagram illustrating one implementation of a gNB 1160. The gNB 1160 may be an example of the gNB 160 described in connection with FIG. 1. The gNB 1160 may include a higher layer processor 1123, a DL transmitter 1125, a UL receiver 1133, and one or more antenna 1131. The DL transmitter 1125 may include a PDCCH transmitter 1127 and a PDSCH transmitter 1129. The UL receiver 1133 may include a PUCCH receiver 1135 and a PUSCH receiver 1137.

The higher layer processor 1123 may manage physical layer's behaviors (the DL transmitter's and the UL receiver's behaviors) and provide higher layer parameters to the physical layer. The higher layer processor 1123 may obtain transport blocks from the physical layer. The higher layer processor 1123 may send/acquire higher layer messages such as an RRC message and MAC message to/from a UE's higher layer. The higher layer processor 1123 may provide the PDSCH transmitter transport blocks and provide the PDCCH transmitter transmission parameters related to the transport blocks.

The DL transmitter 1125 may multiplex downlink physical channels and downlink physical signals (including reservation signal) and transmit them via transmission antennas 1131. The UL receiver 1133 may receive multiplexed uplink physical channels and uplink physical signals via receiving antennas 1131 and de-multiplex them. The PUCCH receiver 1135 may provide the higher layer processor 1123 UCI. The PUSCH receiver 1137 may provide the higher layer processor 1123 received transport blocks.

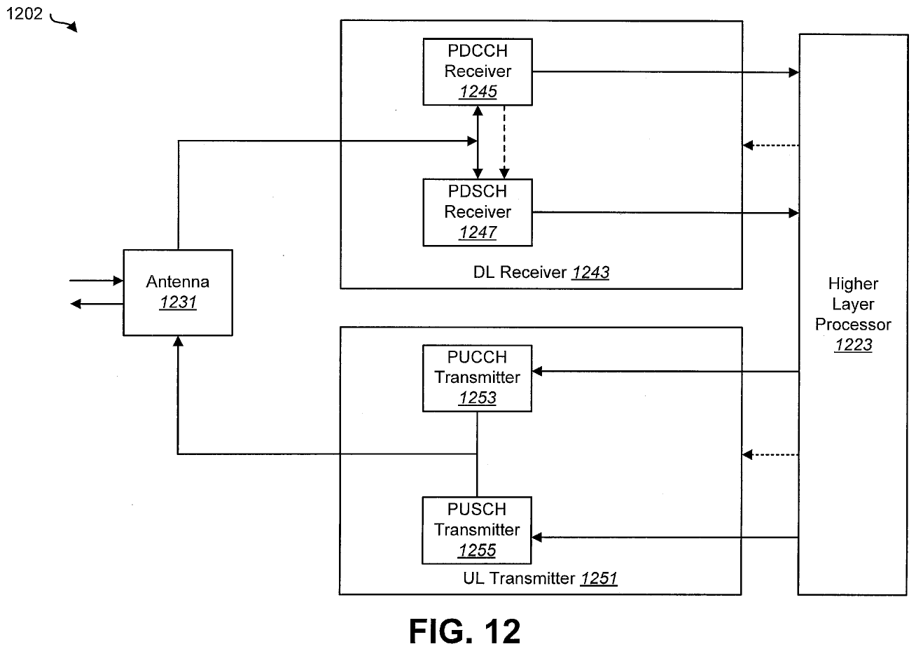

FIG. 12 is a block diagram illustrating one implementation of a UE 1202. The UE 1202 may be an example of the UE 102 described in connection with FIG. 1. The UE 1202 may include a higher layer processor 1223, a UL transmitter 1251, a DL receiver 1243, and one or more antenna 1231. The UL transmitter 1251 may include a PUCCH transmitter 1253 and a PUSCH transmitter 1255. The DL receiver 1243 may include a PDCCH receiver 1245 and a PDSCH receiver 1247.

The higher layer processor 1223 may manage physical layer's behaviors (the UL transmitter's and the DL receiver's behaviors) and provide higher layer parameters to the physical layer. The higher layer processor 1223 may obtain transport blocks from the physical layer. The higher layer processor 1223 may send/acquire higher layer messages such as an RRC message and MAC message to/from a UE's higher layer. The higher layer processor 1223 may provide the PUSCH transmitter transport blocks and provide the PUCCH transmitter 1253 UCI.

The DL receiver 1243 may receive multiplexed downlink physical channels and downlink physical signals via receiving antennas 1231 and de-multiplex them. The PDCCH receiver 1245 may provide the higher layer processor 1223 DCI. The PDSCH receiver 1247 may provide the higher layer processor 1223 received transport blocks.

As described herein, some methods for the DL and/or UL transmissions may be applied (e.g., specified). Here, the combination of one or more of the some methods described herein may be applied for the DL and/or UL transmission. The combination of the one or more of the some methods described herein may not be precluded in the described systems and methods.

It should be noted that names of physical channels described herein are examples. The other names such as “NRPDCCH, NRPDSCH, NRPUCCH and NRPUSCH,” “new Generation-(G)PDCCH, GPDSCH, GPUCCH and GPUSCH” or the like can be used.

The term “computer-readable medium” refers to any available medium that can be accessed by a computer or a processor. The term “computer-readable medium,” as used herein, may denote a computer- and/or processor-readable medium that is non-transitory and tangible. By way of example and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD and the like), a magnetic storage medium (for example, a magnetic tape, a flexible disk and the like) and the like, any one may be possible. Furthermore, in some cases, the function according to the described systems and methods described herein is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described herein may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller, or a state machine. The general-purpose processor or each circuit described herein may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

### CROSS REFERENCE

This Nonprovisional application claims priority under 35 U.S.C. § 119 on provisional Application No. 62/701,215 on Jul. 20, 2018, the entire contents of which are hereby incorporated by reference.

1. A user equipment (UE) comprising:
receiving circuitry configured to receive a downlink control information (DCI) format, the DCI format comprising a channel state information (CSI) request field set to trigger an aperiodic CSI reporting, and
transmitting circuitry configured to perform, based on the detection of the DCI format, the aperiodic CSI reporting comprising a channel quality indicator (CQI) using a physical uplink shared channel (PUSCH), wherein
in a case that cyclic redundancy check (CRC) attached to the DCI format is scrambled by a cell radio network temporary identifier (C-RNTI), a first CQI table is used for interpretation for indices of the CQI, and
in a case that CRC attached to the DCI format is scrambled by a first RNTI different from the C-RNTI, a second CQI table is used for interpretation for indices of the CQI.

2. The UE of claim 1, wherein:
the first RNTI is used for identifying a modulation and coding scheme (MCS) index table from more than one MCS index tables to determine a modulation order and/or a target coding rate.

3. A user equipment (UE), comprising:
receiving circuitry configured to receive a radio resource control (RRC) message comprising information used for configuring a correspondence between a trigger state of a channel state information (CSI) request field and a channel quality indicator (CQI) table,
the receiving circuitry configured to receive a downlink control information (DCI) format, the DCI format comprising a CSI request field set to trigger an aperiodic CSI reporting, and
transmitting circuitry configured to perform, based on the detection of the DCI format, the aperiodic CSI reporting comprising a channel quality indicator (CQI) using a physical uplink shared channel (PUSCH), wherein
the CQI table used for interpretation for indices of the CQI is determined based on the information and the trigger state of the CSI request field.

4. A base station apparatus comprising:
transmitting circuitry configured to transmit a downlink control information (DCI) format, the DCI format comprising a channel state information (CSI) request field set to trigger an aperiodic CSI reporting, and
receiving circuitry configured to receive, based on the DCI format, the aperiodic CSI reporting comprising CQI using a physical uplink shared channel (PUSCH), wherein
in a case that cyclic redundancy check (CRC) attached to the DCI format is scrambled by a cell radio network temporary identifier (C-RNTI), a first CQI table is used for interpretation for indices of the CQI, and
in a case that CRC attached to the DCI format is scrambled by a first RNTI different from the C-RNTI, a second CQI table is used for interpretation for indices of the CQI.

5. The base station apparatus of claim 4, wherein:
the first RNTI is used for identifying a modulation and coding scheme (MCS) index table from more than one MCS index tables to determine a modulation order and/or a target coding rate.

6. A base station apparatus comprising:
transmitting circuitry configured to transmit a radio resource control (RRC) message comprising information used for configuring a correspondence between a trigger state of a channel state information (CSI) request field and a channel quality indicator (CQI) table,
the transmitting circuitry configured to transmit a downlink control information (DCI) format, the DCI format comprising a CSI request field set to trigger an aperiodic CSI reporting, and
receiving circuitry configured to receive, based on the DCI format, the aperiodic CSI reporting comprising CQI using a physical uplink shared channel (PUSCH), wherein
the CQI table used for interpretation for indices of the CQI is determined based on the information and the trigger state of the CSI request field.

7. A communication method of a user equipment (UE), comprising:
receiving a downlink control information (DCI) format, the DCI format comprising a channel state information (CSI) request field set to trigger an aperiodic CSI reporting, and
performing, based on the detection of the DCI format, the aperiodic CSI reporting comprising a channel quality indicator (CQI) using a physical uplink shared channel (PUSCH), wherein
in a case that cyclic redundancy check (CRC) attached to the DCI format is scrambled by a cell radio network temporary identifier (C-RNTI), a first CQI table is used for interpretation for indices of the CQI, and
in a case that CRC attached to the DCI format is scrambled by a first RNTI different from the C-RNTI, a second CQI table is used for interpretation for indices of the CQI.

8. The communication method of claim 7, wherein:
the first RNTI is used for identifying a modulation and coding scheme (MCS) index table from more than one MCS index tables to determine a modulation order and/or a target coding rate.

9. A communication method of a user equipment (UE), comprising:
receiving a radio resource control (RRC) message comprising information used for configuring a correspondence between a trigger state of a channel state information (CSI) request field and a channel quality indicator (CQI) table,
receiving a downlink control information (DCI) format, the DCI format comprising a CSI request field set to trigger an aperiodic CSI reporting, and
transmitting circuitry configured to perform, based on the detection of the DCI format, the aperiodic CSI reporting comprising a channel quality indicator (CQI) using a physical uplink shared channel (PUSCH), wherein
the CQI table used for interpretation for indices of the CQI is determined based on the information and the trigger state of the CSI request field.

10. A communication method of a base station apparatus, comprising:
transmitting a downlink control information (DCI) format, the DCI format comprising a channel state information (CSI) request field set to trigger an aperiodic CSI reporting, and
receiving, based on the DCI format, the aperiodic CSI reporting comprising CQI using a physical uplink shared channel (PUSCH), wherein
in a case that cyclic redundancy check (CRC) attached to the DCI format is scrambled by a cell radio network temporary identifier (C-RNTI), a first CQI table is used for interpretation for indices of the CQI, and
in a case that CRC attached to the DCI format is scrambled by a first RNTI different from the C-RNTI, a second CQI table is used for interpretation for indices of the CQI.

11. The communication method of claim 10, wherein:
the first RNTI is used for identifying a modulation and coding scheme (MCS) index table from more than one MCS index tables to determine a modulation order and/or a target coding rate.

12. A communication method of a base station apparatus comprising:
transmitting a radio resource control (RRC) message comprising information used for configuring a correspondence between a trigger state of a channel state information (CSI) request field and a channel quality indicator (CQI) table,
transmitting a downlink control information (DCI) format, the DCI format comprising a CSI request field set to trigger an aperiodic CSI reporting, and
receiving, based on the DCI format, the aperiodic CSI reporting comprising CQI using a physical uplink shared channel (PUSCH), wherein
the CQI table used for interpretation for indices of the CQI is determined based on the information and the trigger state of the CSI request field.
